(19) United States
(12) Patent Application Publication
(10) Pub. No.: US 2024/0274025 A1
(43) Pub. Date: Aug. 15, 2024

(54) METHOD AND APPARATUS FOR AUTOMATED CONTENT DATABASE CREATION AND REAL-TIME, ADAPTIVE TUTORING AND GRADING

(71) Applicant: Class Genius, Inc., Austin, TX (US)

(72) Inventors: Katelijn Vleugels, Austin, TX (US); Roel Peeters, Austin, TX (US)

(21) Appl. No.: 18/441,304

(22) Filed: Feb. 14, 2024

Related U.S. Application Data
(60) Provisional application No. 63/445,352, filed on Feb. 14, 2023.

(51) Int. Cl. G09B 7/00

(52) U.S. Cl. CPC G09B 7/00

(57) ABSTRACT

The present disclosure relates to a system and method for automated generation and adaptation of an educational content database, alongside adaptive tutoring and grading functionalities. Specifically, the invention employs generative and computational Artificial Intelligence (AI) to autonomously create and update a repository of educational materials or elements thereof. This approach facilitates the provision of customized educational content and assessments, tailored to the unique requirements and learning paces of individual students. The system dynamically adjusts content embeddings based on performance data and feedback to generate customized educational assessments. Furthermore, the invention encompasses methods for providing interactive tutoring, as well as grading student responses to assessment prompts through AI-driven analysis. This novel solution addresses the prevalent challenges of educator shortages and the limitations of conventional “one-size-fits-all” educational approaches, offering a scalable, effective, and accessible educational tool that enhances student engagement and learning outcomes.

### BACKGROUND

The present invention is related to the field of education, and more specifically to solutions that address the critical teacher shortage and make education more accessible, engaging, and effective.

The current state of education is facing a critical challenge as many educators are burnt out due to a high workload, stressful work circumstances, and unattractive pay. As a result, many educators are leaving the field and not enough young talent is entering the field, leaving school administrators struggling to find sufficient and qualified educators.

Furthermore, access to an education is expensive and not everyone can afford it. This creates a situation where access to education is one of the biggest factors for success in a child's life, yet it is only accessible to a select few based on their socio-economic background. The result is that many children are denied the opportunity to succeed and reach their full potential.

Moreover, the quality of education is not where it needs to be. It has been shown that learning is most effective if the curriculum and teaching method are customized to a student's abilities, needs, and preferences. Yet, today's teaching is largely done using a “one size fits all” model, which does not consider the individual needs of each student. This results in a suboptimal learning experience for many students, who may not be fully engaged in their education and may not be able to reach their full potential.

Online educational platforms, such as Kahn Academy, CommonLit, and Zearn, have become increasingly popular in recent years as a means of providing students with access to educational resources and materials. These platforms provide a suite of online resources that can be accessed from anywhere with an internet connection, which makes it easy for students to learn on their own schedule. However, despite their convenience and accessibility, these platforms have several limitations that can negatively impact a student's learning experience.

One limitation is the lack of adaptability to a student's individual needs and pace of learning. These platforms often provide a set curriculum or set of resources that are not tailored to a student's specific learning needs, making it challenging to keep students engaged and motivated. Additionally, these platforms lack personalized and interactive instruction and support, which means that students are not getting the one-on-one, individualized help they need if they are struggling with a particular concept or ready to be challenged at the next level.

Another limitation is the content database. A content database is a repository of educational materials. A content database may contain educational texts or other multi-modal educational content, practice problems, assessment questions, science-based curricula, etc. The content database is typically created manually, which is time-consuming and requires input from a human subject matter expert. This results in a content database that is limited in size and breadth, which limits the resources available to students. Furthermore, the built-in assessment capabilities of these platforms are limited. Assessments are typically offered as multiple-choice questions that can be easily evaluated programmatically with simple logic. This method of evaluation does not allow for the same quality and depth of assessing important skills such as comprehension, critical thinking, and writing skills as methods that allow free-form answers.

Finally, the way in which these platforms have been designed and built does not lend itself to individualizing the format of content delivery. A “One size fits all” format may not work well for everyone. For example, Kahn Academy relies heavily on video lessons, which may not be the best format for all students. Some students may find it difficult to focus on a video lesson for an extended period of time, and others may have difficulty understanding the material presented in a video format.

In recent years, new solutions have emerged that aim to address some of the limitations of existing online educational platforms. One of these solutions is the use of machine learning and artificial intelligence to build adaptive learning systems. These systems leverage AI algorithms to analyze student data and adjust the learning experience in real-time to meet the needs of individual students. Examples of such systems include Knewton, ALEKS, Dreambox Learning, and Carnegie Learning. While these adaptive learning systems represent a significant step forward in offering a more personalized learning experience, they fall short in addressing some of the other limitations such as limited and static content resources, generic content delivery formats, lack of interactivity, and limited real-time feedback and built-in assessment capabilities.

Other solutions, like Grammarly, have emerged that use a set of rules, machine learning, and natural language-based programming to analyze text input and identify errors in the spelling or grammar. They then provide real-time feedback to the an end user (eg student), suggesting corrections to the identified errors. Similar real-time feedback tools also exist for coding. Platforms like for example Codecademy, CodePen, and Repl.it provide real-time feedback on student's coding skills and help them to find errors and improve their coding skills

While solutions like Grammarly or Codecademy can be helpful to provide a student feedback in specific areas related to the mechanical aspects of writing or coding, they are not capable of providing feedback in more complex skill areas such as critical thinking or comprehension.

Additionally, solutions that use machine learning and natural language processing to score assessments or assignments have also been developed. For instance, Intelligent Essay Assessor uses Latent Semantic Analysis, a technique in natural language processing, to score written essays. However, solutions like Intelligent Essay Assessor are designed for a specific purpose and are trained on a specialized dataset, making them useful for one specific task only.

The special-purpose nature of existing feedback and assessment solutions limits their usefulness in providing comprehensive feedback and guidance to students. These solutions are designed to perform a specific task, such as grammar correction or essay scoring, and may not be able to provide feedback on other areas of the student's learning. Furthermore, since they are trained on specific datasets, they may not be able to handle a diverse range of content. Finally, these solutions do not adapt to the student's learning style and provide personalized instruction, which is necessary for a comprehensive feedback and guidance.

Therefore, there is a clear need for novel methods and solutions that address the remaining limitations of existing online educational platforms, such as access to a broad set of content resources that can be created, updated, or expanded dynamically and on-demand, the ability to adapt the content delivery format to a end user's learning style or preferences, interactive instruction and support, and more sophisticated built-in assessment capabilities that can assess important skills such as comprehension, critical thinking, and writing skills without requiring inputs from a human expert.

Recent advances in the fields of Computational and Generative Artificial Intelligence hold great promise for generating vast amounts of high-quality content on demand and converting content to new formats, yet their use today is mostly limited to use in the entertainment and media industries for the creation of creative content, in customer service to provide quick and automated response to customer queries, or by marketing organizations to develop appealing sales and marketing collateral.

One notable example is Wolfram Alpha, a computational knowledge engine that can answer natural language queries on computable or quantifiable topics with a combination of curated data, algorithms, and computational intelligence. The platform can create practice problems on specific topics and provide detailed explanations of the results, including interactive visualizations and graphs to help end users understand the information. However, it's important to note that Wolfram Alpha is not a general-purpose AI and while it excels in answering questions that can be quantified, it falls short when it comes to more general understanding of a topic.

Another notable example is OpenAI, a general-purpose Artificial Intelligence engine that is designed to learn and generalize on its own. Unlike Wolfram Alpha, OpenAI uses a more unsupervised approach by analyzing and understanding large amounts of data and can execute a broad variety of queries and tasks.

In addition to these two major AI systems, there are also special-purpose AI platforms that have emerged in recent years, such as D-DI, Fliki.ai, steve.ai, murf.ai, Descript, Synthesia, and Google Cloud Text-to-Speech. These platforms are designed for specific tasks such as creating videos, audio, animations, and speech from written text or images. These special-purpose AI platforms have the potential to revolutionize content creation by automating repetitive tasks and allowing for the creation of high-quality content at a fraction of the time and cost. However, the specialized nature of these platforms also limits their usefulness in more general applications, and they may not be able to handle a diverse range of content.

Novel methods that leverage these latest developments in computational and generative AI to solve the critical problem of teacher shortages and improve access and equity to education, as well an enhance the quality of education through interactive, personalized learning experiences are thus desirable.

Such methods could enable the creation of curriculum content without the input of a human expert and in a way that is not only engaging and effective, but also up-to-date and relevant. As the content could be generated automatically, it would become possible to create multiple derivatives and variations that can cater to the needs of different students and learning environments, such as leveling the complexity level to different grade or Lexile reading complexity levels. Furthermore, as new content could be generated in real-time, new lessons could be created on-demand, which could be customized to the specific needs of a student or group. This opens up new possibilities for creating high-quality educational content that can be adapted to the needs of different students, cultures, and learning environments.

Such novel methods and systems could also help to address the teacher shortage challenge by automating the grading and review of assignments or assessments. This would not only reduce the workload of teachers thereby freeing up valuable time for teachers to focus on other important aspects of their work, but it could also make the grading and feedback process more consistent and objective. By removing human bias, the grading process can become more objective, and students can receive accurate and consistent feedback on their work. Furthermore, novel methods and systems that help to detect cheating could be used to ensure that students receive a fair evaluation of their work.

### SUMMARY

Aspects and embodiments of the present invention are generally directed to systems and methods for providing adaptive and automated learning pathways. One such set of embodiments describes a method for automatic creation of a content database or an element of a content database using an interface to a generative or computational Artificial Intelligence (“AI”) model including the steps of: determining a set of prompts used to query the AI model, creating a set of attribute values for a first content element, creating the first content element by requesting and receiving from the AI model portions of a content element and processing the portions of the content element to create a first content element.

Further aspects and embodiment of the invention are generally directed to systems and methods that provide automated and adaptive generation of customized educational assessments leveraging vectorized representations (embeddings) to deeply understand both user (eg educator, content creator) input criteria and educational content. The system dynamically adjusts content embeddings based on aggregated performance data and real-time feedback, enhancing personalized learning experiences by tailoring difficulty levels, content relevance, and format relevance to improve learning outcomes.

Further aspects and embodiments of the invention are generally directed to systems and methods that provide automated, real-time tutoring and grading by leveraging an interface to a generative or computational AI-based system. One such set of embodiments describes a method for delivering interactive tutoring and providing personalized feedback to a user (eg student) on their answers to a skills-assessment prompt including the steps of presenting a skills-assessment prompt to a user, receiving a user's answer to the skills-assessment prompt, determining a reference answer; accessing an interface to an AI-based content generator to generate explanation-specific content based on the comparison of the user's answer to the reference answer.

Another set of embodiments describes a method for grading a assessment taker's level of mastery of a specific skill using an interface to an Artificial Intelligence model including the steps of: presenting a mastery-assessment prompt to an assessment taker (eg student), receiving an assessment taker's response to the mastery-assessment prompt, defining a prompt needed to request from the AI model a grading of the assessment taker's response to the mastery-assessment prompt; access the interface to the AI model to send a grading request and receive a grading response, and process the grading response to extract grade-specific content.

Yet another set of embodiments describe another method for customizing the delivery format of educational content by leveraging an interface to a generative Artificial Intelligence model.

Still other aspects, embodiments, implementations, and advantages of these examples are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment in any manner consistent with at least one of the objectives, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1A is a flow diagram illustrating a method for creating an educational content database;

FIG. 1B is an example of a content element format of an education content database.

FIG. 1C is a block diagram illustrating aspects and embodiments of a content database creation system;

FIG. 1D is a functional diagram of an adaptive system for automated generation of customized educational assessments using embeddings;

FIG. 1E is a functional diagram of a content embeddings creation subsystem;

FIG. 1F is a functional diagram of an assessment creation subsystem;

FIG. 1G is a functional diagram of an assessment generator component;

FIG. 1H is a functional diagram of an embeddings optimizer subsystem;

FIG. 2A is a diagram illustrating the data flow for an interactive tutoring system;

FIG. 2B is a block diagram illustrating aspects and embodiments of an interactive tutoring system;

FIG. 3A is a flow diagram illustrating an automated grading method;

FIG. 3B is a block diagram illustrating aspects and embodiments of an automated grading system.

### DETAILED DESCRIPTION

The following description is merely exemplary in nature and is not intended to limit the present disclosure, application, or uses. It should be understood that, throughout the drawings, corresponding reference numerals indicate like or corresponding parts and features.

Various embodiments and implementations of the present invention provide systems and methods for implementing an online educational platform that leverages a natural language interface to one or more Artificial Intelligence models to achieve high levels of scalability and automation and deliver personalized and interactive learning pathways.

The Artificial Intelligence models may be based on computational Artificial Intelligence or generative Artificial Intelligence. Other Artificial Intelligence and computing methods and models are also possible. The interface to the Artificial Intelligence models may be natural language based.

### Systems and Methods for Content Database Creation

In embodiments relating to online or mobile educational platforms, the systems and methods described herein may include a method and apparatus for creating an educational content database using an interface to at least one computational or generative Artificial Intelligence (AI) model. A content database is a repository of educational materials. A content database may contain textbook content, practice problems, assessment questions, science-based curricula, etc. In case the content are practice problems or assessment questions, the content database may also be referred to as an assessments database. The method may for example create the educational content database based on a pre-defined or pre-configured curriculum outline. While many of the embodiments disclosed herein describe the creation educational content database, the same or similar methods and systems may be used for creation of other content databases. A content element may for example be a piece of text, a practice problem or set of practice problems, an assessment question or set of assessment questions, or a writing prompt or set of writing prompts. Other examples are also possible. A content element may also include an answer key or a sample response. A content element may also consist of a combination of pieces of texts, practice problems, assessment questions, writing prompts, etc. A curriculum content element is generally a content element that contains educational material used for instruction (content from a textbook, lesson plan, science-based curriculum etc). An assessment content element is generally a content element that contains educational material used to evaluate a student (set of questions, set of practice problems, exam, quiz, writing prompts, etc). An assessment content may also include text. For example, if the assessment is a reading comprehension assessment, the assessment content element may include a passage, a set of questions, an answer key, and/or example answers.

In specific embodiments a portion of the content database already exists, and one or more methods described herein are used to create additional content elements. In other embodiments a system may access an existing database or upload content from an existing database and use one or more methods described in this specification to create one or more content elements of a separate content database or to add create one or more content elements to add to the existing database. For example, an assessment content element may already exist for a reading comprehension assignment on the topic of “the invention of the book press” for a specific grader or Lexile reading complexity level, and the invention described herein may be used to create one or more comprehension assignments on the same topic and/or with the same information as that of the existing assessment content element, but simplified to be suitable for a lower grader or matched to a lower Lexile reading complexity level. Other examples are of course also possible.

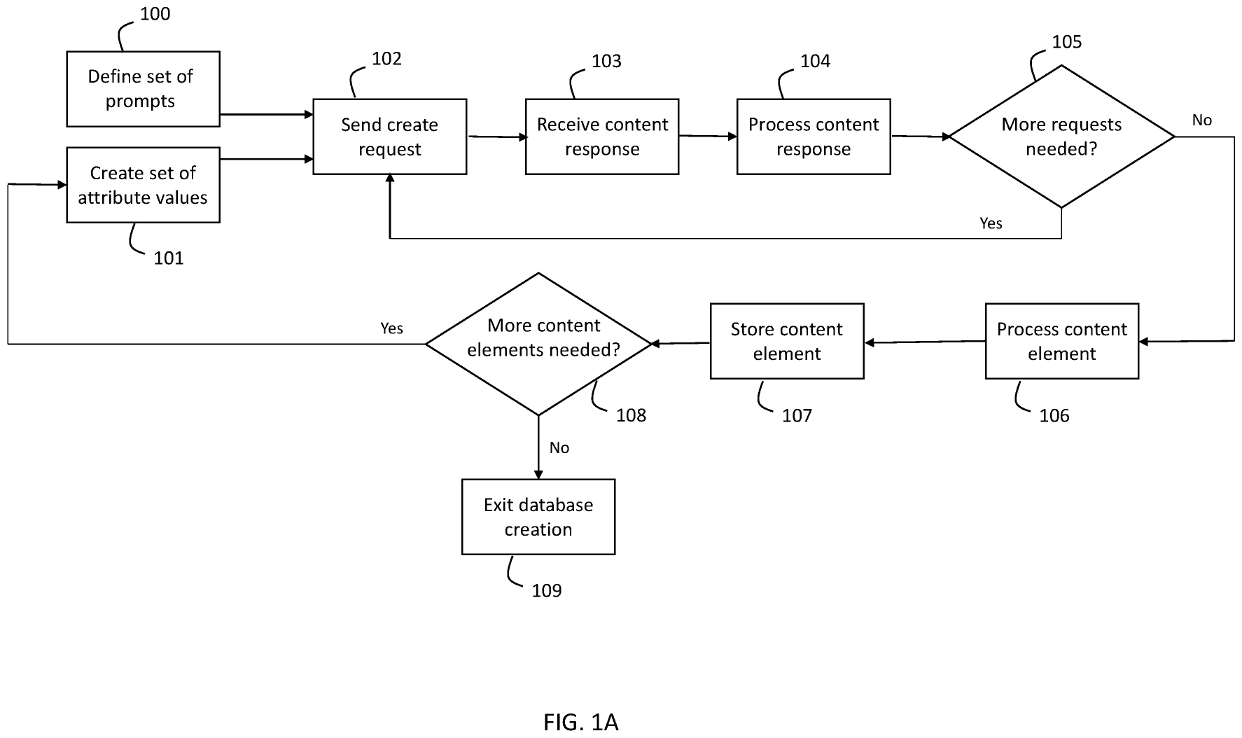

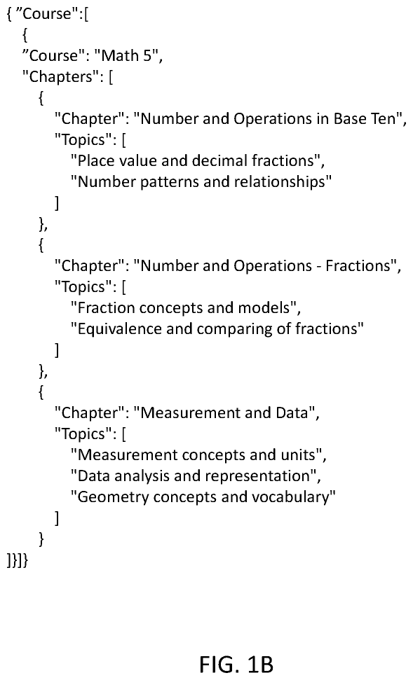

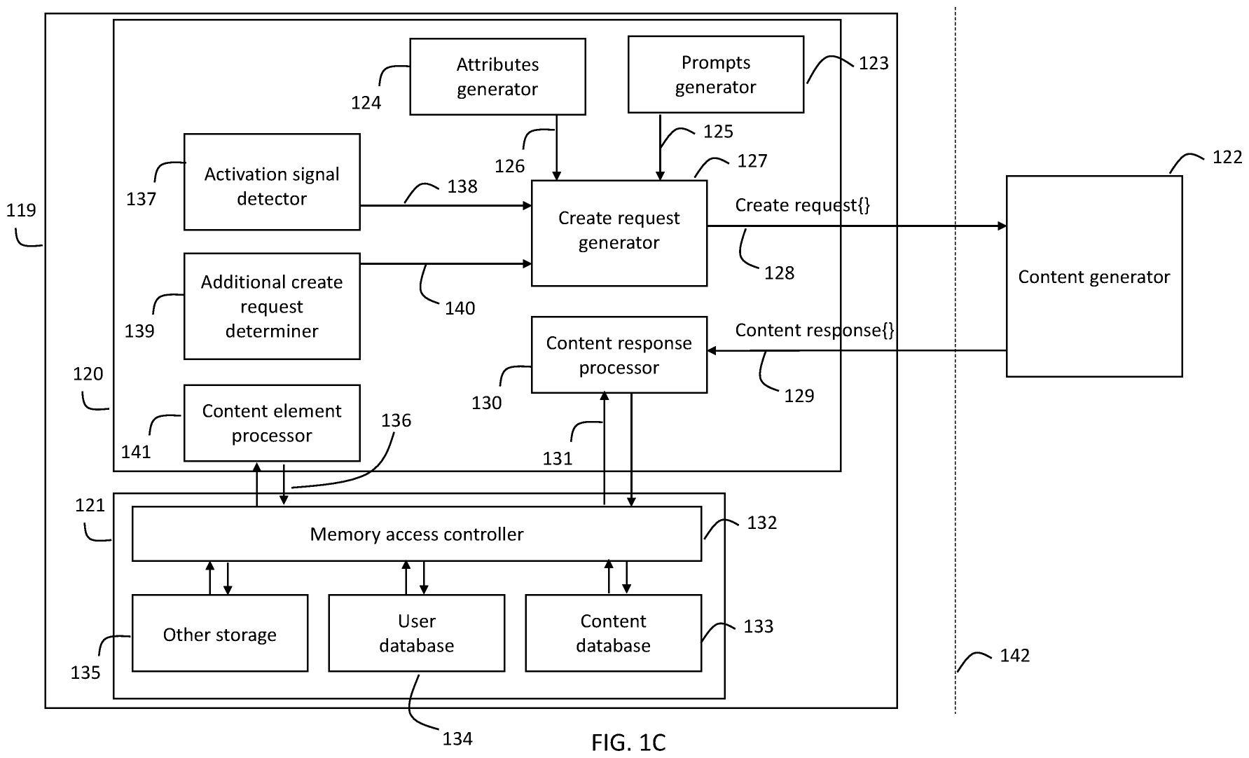

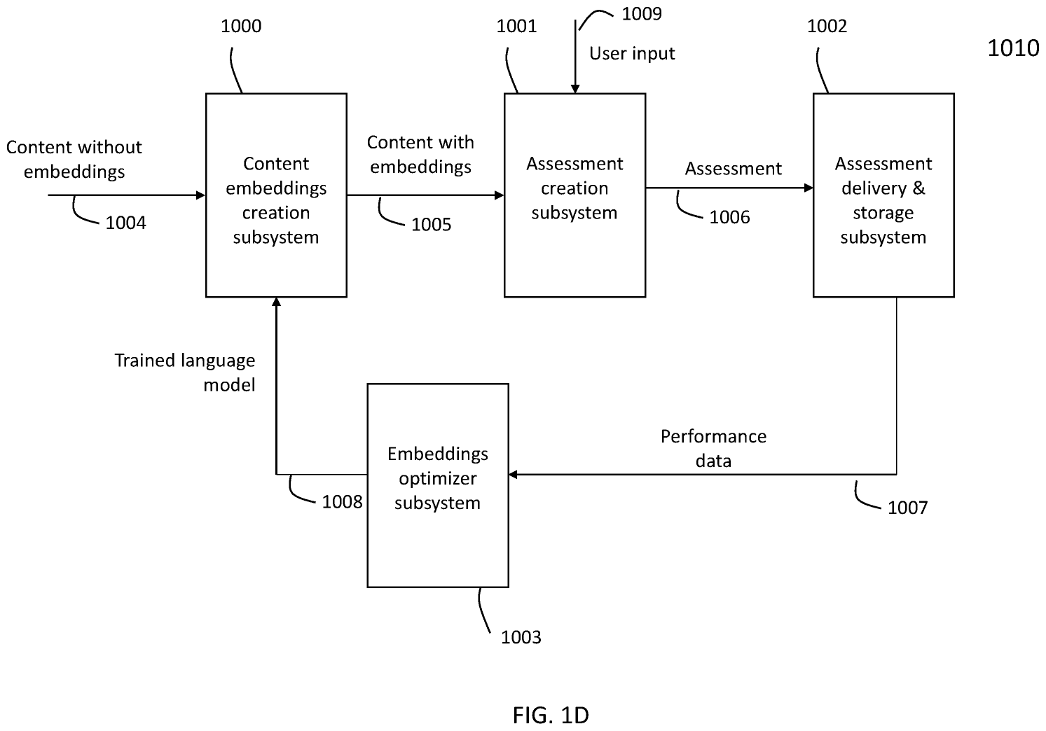

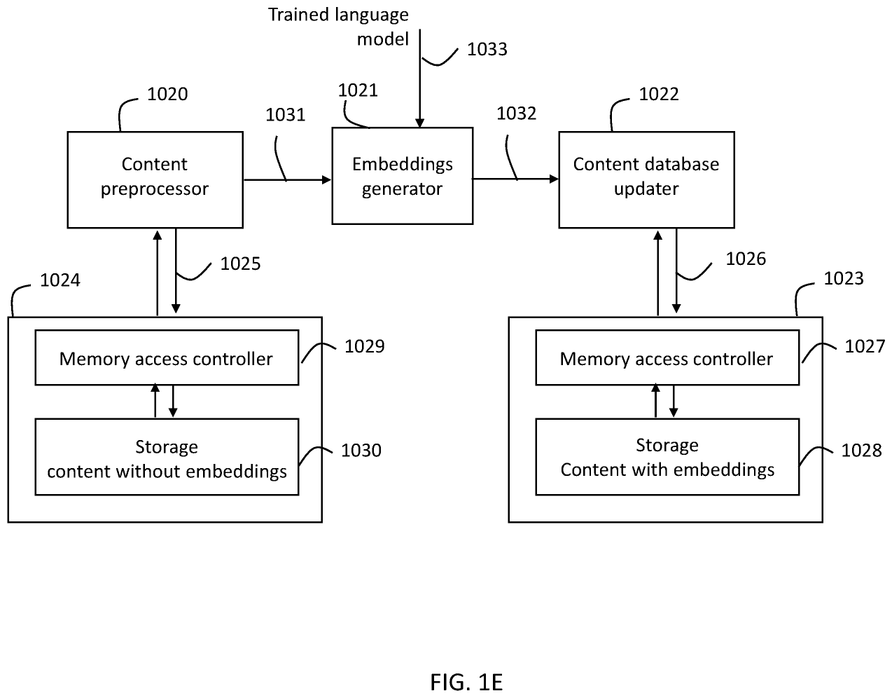

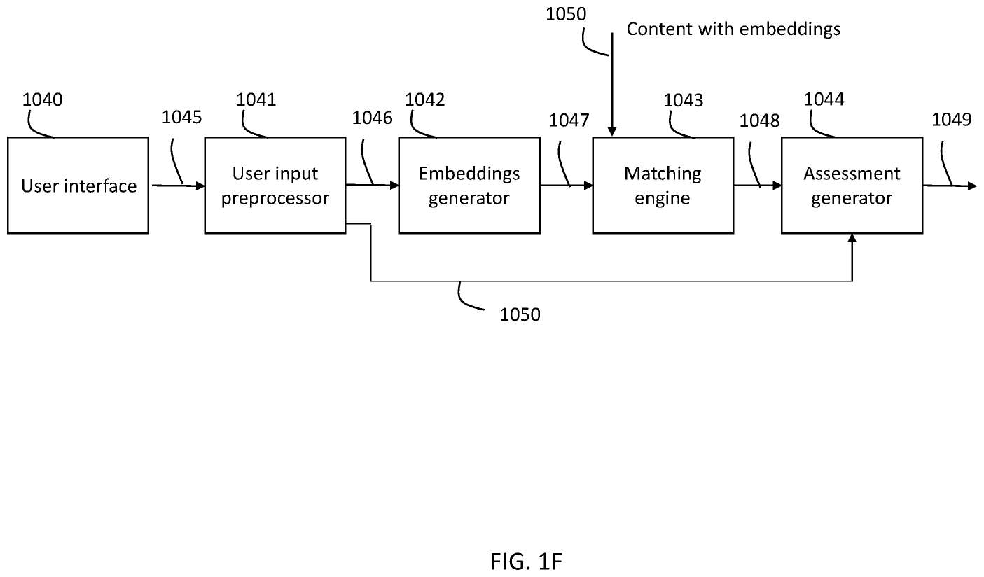

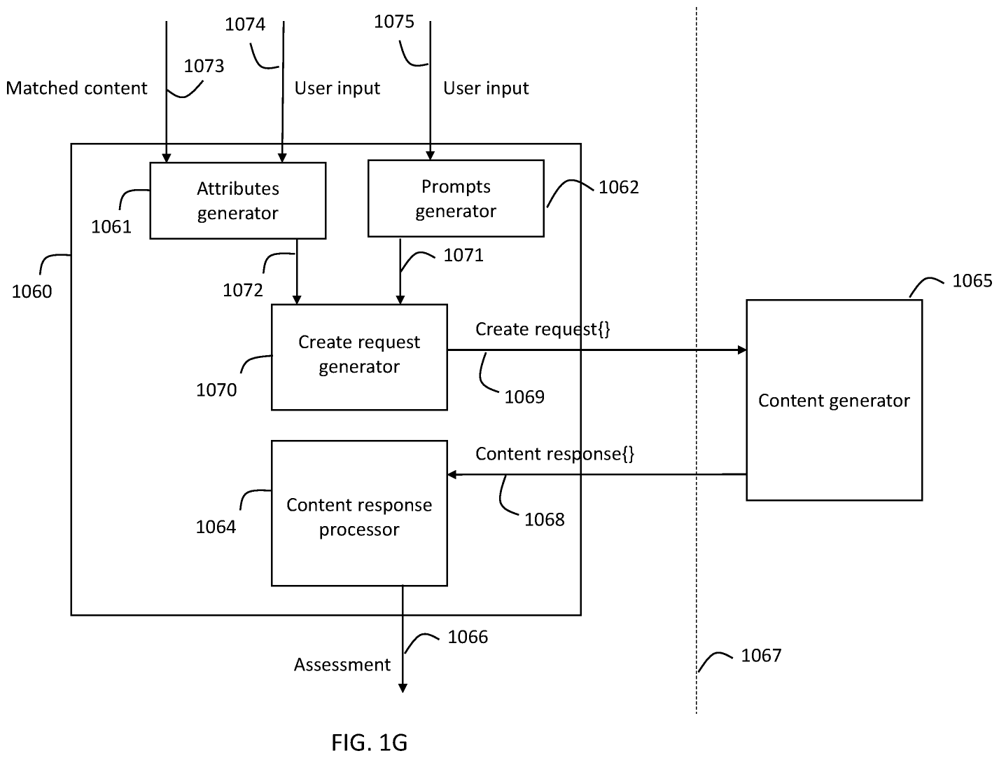

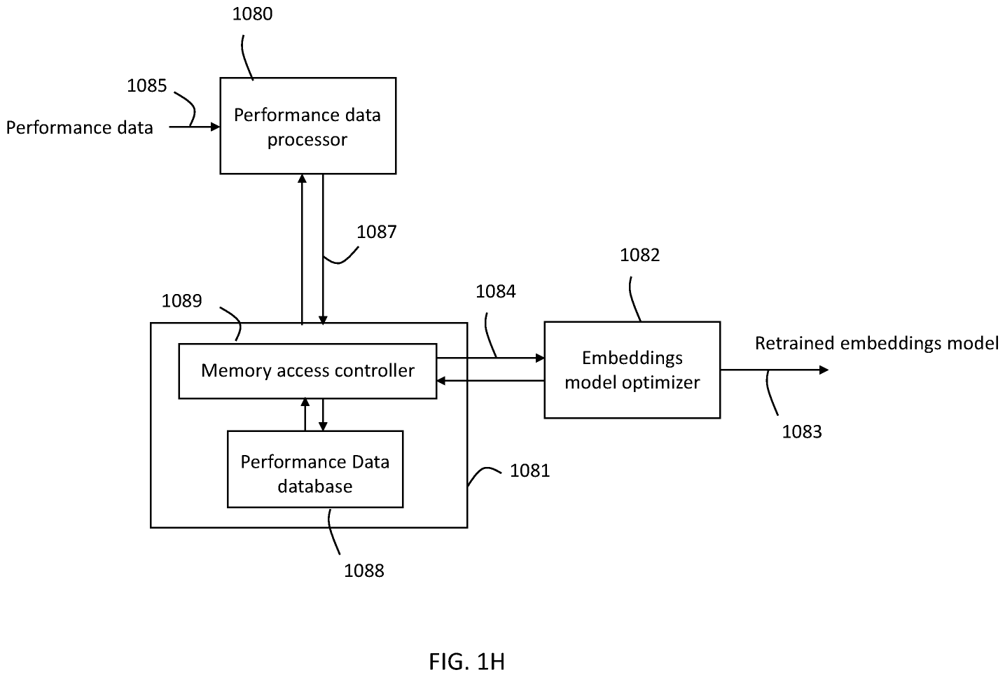

FIG. 1A is a diagram illustrating a method for creating an educational content database according to various embodiments of the invention. The method includes defining a set of prompts 100 used to query an AI model, where a set of prompts includes at least one prompt required to generate a content element for the educational content database. The method also includes creating a first set of attribute values (step 101) for a first content element. The set of attribute values may include, but is not limited to, subject, topic, characteristics of the content element, format type, format characteristics, format of returned content response, approved or recommended sources, examples of similar content elements, additional context, and more.

Examples of characteristics of the content element may include genre, difficulty level, style tone, length indication, Lexile reading complexity level (or an equivalent standard metric for quantifying reading complexity levels), Webb's Depth of knowledge level (or an equivalent standard metric for quantifying the degree of knowledge and thinking required). Examples of format characteristics of the content element may include language, font size, maximum number of words per slide, voice tone, voice emotion, pace, accentuation of specific words or phrases, difficulty level of vocabulary. Examples of format of the returned content response may include language, syntax of the response, use of specific tags in the response, capitalization or punctuation, maximum length, and test format such as open-ended, fill in the blanks, multiple choice etc.

Attribute values for one or more attributes may for example be stored in one or more JSON objects but other storage formats are of course also possible. An example of a JSON object that stores the name-value pairs of a math curriculum is shown in FIG. 1B. In another example, the attribute values for attributes such as for example difficulty level may be stored as a simple list or array. Other formats are of course also possible. An example of an array format would be:

$$difficulty = [ {}^{′} {easy}^{′} , {}^{′} {typical}^{′} , {}^{′} {challenging}^{′} ]$$

The method also includes creating a first content element, by sending at least one create request (step 102) for at least a portion of the first content element over the interface wherein the create request includes at least one prompt from the set of prompts and one or more attribute values from the first set of attribute values, receiving a content response (step 103) with the at least a portion of the first content element over the interface, processing the content response (step 104) to extract or derive the at least a portion of the first content element, determining if additional create requests (step 105) are needed, and if so, sending additional create requests (step 102) for additional portions of the first content element and receiving (step 103) and processing (step 104) the additional content responses to extract or derive the one or more additional portions of said first content element. The create request may include among other things at least one prompt from the set of prompts. In specific embodiments determining if additional create questions are needed may not be necessary.

The method further includes processing the first content element (step 106), which may include one or more of the following: concatenating portions of the first content element to create a first content element, tagging the first content element with one or more attribute values from the set of attributes, and storing the first content element (step 107), possibly along with one or more tags, in an educational content database. The content element may for example be stored as a JSON object but other objects are also possible.

The method may further include determining if additional content elements are needed (step 108) and if so, creating a second set of attribute values (step 101) for a second content element, wherein the creation of a second set of attribute values includes taking the first set of attribute values and modifying at least one attribute value of the first set of attributes to create a second set of attribute values, and sending at least one create request for the second content element over the interface, wherein said create request may among other things include a prompt from the set of prompts and at least one attribute value from the second set of attribute values.

The method may further include repeating the remaining steps 102 through 107 described for the creation and storage of the first content element to create and store a second storage element and upon completion of those steps determining if additional content elements are needed 108. When no further new content elements need to be created, the method may exit the database creation routine (step 109).

The educational content database may be personalized for a user (eg student) or a group of users (eg group of students). The personalization may include making one or more sets of attributes specific to the users or group of users, requesting and receiving one or more user-specific content elements, and storing the user-specific content elements in a user-specific educational content database or as a user-specific entry in a central educational content database.

One or more attribute values from the first and/or second set of attributes may also be generated using the input from an authority, such as for example a student, an educator, an administrator, or a parent. The authority's input can also be generated by a digital avatar or digital assistant representing the authority.

The educational content database may be created non-real time, separate from the time when content is consumed by a user. Alternatively, one or more content elements may be created on-demand. At least one attribute value, and as such a set of attribute values, may be created on-demand, for example upon receiving an activation signal that indicates one or more content elements need to be generated. An activation signal could for example be sent upon a user opening up an educational app or starting a lesson or practice, but other trigger signals are also possible. Upon or after receiving the activation signal, the system may create at least one attribute based on one or more of the following: one or more previously created sets of attributes, one or more user inputs, information stored in a user profile, historical data stored from previous interactions with the online educational platform.

In specific embodiments of the invention, a portion or all of the create requests may be formatted to interact with a conversational or natural language-based AI system.

The novel methods and systems described herein enable programmatic creation of a database of practice problems and/or other educational content according to a pre-configured curriculum, leveraging the natural language interface to an AI model. The educational content database created may be personalized and may be updated on-demand to meet the needs of individual users or groups of users.

In various embodiments of the invention, the educational content database creation apparatus may be designed to interact with one or more content generators that use computational or generative AI models (such as Large Language Models) to create new content. The content generator(s) may be implemented by hardware circuitry, by program instructions that are executed by a general-purpose processor, or by a combination of both. For example, the AI model may be implemented as a set of program instructions that are executed on a central server, utilizing one or more processors and one or storage units in the central server.

In various embodiments of the invention, methods and systems described in this disclosure may be implemented as a set of program instructions that can be stored in memory 121 and that can be executed by a general-purpose or special-purpose processor on an electronic device such as a laptop or mobile phone, or on a central server.

FIG. 1C is a block diagram illustrating an example embodiment of various inventions disclosed herein. It should be noted that for simplicity and clarity reasons not all connections between components are shown. For example, attributes generator 124 and prompts generator 123 may interact with memory 121 or components within memory 121 to store or retrieve data, but those connections are not shown for simplicity and clarity reasons.

Functional components of the content database creation apparatus 119 may be implemented by hardware circuitry, by program instructions that are executed by a general-purpose processor, or by a combination of both. Where it is indicated that a processor does something, it may be that the processor does that thing as a consequence of executing instructions read from an instruction memory wherein the instructions provide for performing that thing. Where it is described that a processor performs a particular process, it may be that part of that process is done separately from the electronic device, in a distributed processing fashion. Thus, a description of a process performed by a processor of the electronic device need not be limited to a processor within the electronic device, but perhaps a processor in a support device that is in communication with the electronic device.

One or more functional components may make use of one or more processing units and one or more memory units on the electronic device or on the server. The system implementation can also be distributed, with some program instructions executed on a processor in a central server and others executed locally on a processor in the content creator's or user's computing device.

The components of the apparatus may include but are not limited to a prompts generator 123, an attributes generator 124, a create request generator 128, a content response processor 130, an additional create request determiner 139, a content element processor 141, a memory access controller 132, and one or more storage components such as for example content database 133, user database 134, and other temporary or permanent storage 135.

The prompts generator 123 may use a general-purpose processor to execute program instructions to generate or select one or more prompts 125 used to query content generator 122. A list, array, or database of prompts may be stored in memory 121 (e.g. in other storage component 135) and prompts generator 123 may use one or more pointers to identify one or more relevant prompts from the list, array, or database of prompts or otherwise access the list, array, or database of prompts for example through memory access controller 132.

The attributes generator 124 may use a general-purpose processor to execute program instructions to define a set of attribute values 126 required for the creation of one or more content elements. Examples of attributes include but are not limited to subject, topic, format type, and format characteristics of the content element. In specific embodiments, the attributes generator 124 may also include an attribute modifier, which modifies attribute values to create a second set of attributes for a second content element, For example, the attributes modifier may use logic to creates a set of attribute values for a second content element from a first set of attribute for a first content element by incrementing at least one index that specifies position of selected attribute value in a JSON object, a list, or an array.

The list(s), array(s), or JSON object(s) of all attributes may be stored in memory unit 121 (e.g. in other storage component 135) and attributes generator 124 may use one or more indices or pointers to identify one or more relevant attribute values from the list(s), array(s), or JSON object(s) of attributes or otherwise access list(s), array(s), or JSON object(s) for example through memory access controller 132.

The create request generator 127 may execute a set of program instructions to send one or more create requests 128, including prompts and attributes, to content generator 122 through AI interface 142 to generate portions of the content element. Content generator 122 may use one or more computational or generative AI models to generate the requested content. The content generator(s) 122 may be implemented as software, hardware, or a combination of both. For example, the AI model may be implemented by hardware circuitry, by program instructions that are executed by a general-purpose or a special-purpose processor, or by a combination of both. The AI-based content generator may be external to the content database creation system and may be communicatively coupled to the content database creation system. It is also possible that the AI-based content generator is embedded within the content database creation system or that certain components of the AI-based content generator are external to the content database creation system and other components are internal.

In one example embodiment, a software program written in python may be executed to send a create request to a generative AI model through the API interface to a Large Language Model. The prompt and create request could for example be represented by the following equations:

$$Prompt = {f}^{″} Quiz me on Course = \{ course \} , Topic = \{ chapter \} , \{ topic \} . \qquad ( Eq . 1 )$$

$$Difficulty level = \{ difficulty \} . Use Format = \{ format \} ,$$

$$Create request = LLM . Completion . create ( engine = {}^{″} my - model - {advanced}^{″} , prompt = prompt , max\_tokens = 200 , stop = None ) , \qquad ( Eq . 2 )$$

wherein {attribute name} corresponds to the attribute value of the attribute name. In the above example, the parameters “course”, “chapter”, “topic”, “difficulty”, and “format” may be attributes, and the attribute generator generates the value for each attribute. In specific embodiments, one or more attribute values may be incorporated in the Prompt (for example as shown in Eq. 1), but attributes may for example also be sent in a Create request alongside a prompt. Other examples and other syntaxes are of course also possible.

The content response processor 130 receives the one or more content responses 129 and may execute program instructions to processes them to extract the content element-specific information.

The content element-specific information may be stored in memory 121 (e.g. in temporary or permanent memory in other storage component 135). The content response processor may use interface 131 to memory access controller 132 to store one or more content element-specific information. They may be stored in temporary memory or in permanent memory.

The additional create request determiner 139 may use, among other things, internal state information, and may execute program instructions to determine if additional create requests are required for the creation of the current content element, and if so, send a signal 140 to the create request generator 128 to create the next create request 128.

If no further create requests are needed to complete the current content element, the content element processor 141 may execute program instructions to process the one or more portions of content element-specific information to create a content element. Processing may include but is not limited to retrieving the one or more portions of content element-specific information from temporary storage using storage access controller, reformatting, concatenating, tagging with one or more of its attributes, and storing the content element in the content database 133, possibly along with the tags, using storage access controller 132. The content elements may be formatted in a standardized format such as JSON object, but other formats are also possible.

In specific embodiments of content database creation apparatus 119, one or more selected attribute values may be specific for a user or a group of users, and those one or more user specific attribute values, may among generic attribute values, be used to generate one or more user-specific or user-group-specific content elements. The created one or more user-specific or user-group-specific content elements may be stored in a user-specific or user-group specific database 134. They may be stored in temporary memory or in permanent memory. Alternatively, or in addition, the created one or more user-specific or user-group-specific content elements may be rendered to the one or more users through a user interface (not shown in FIG. 1C).

In one set of embodiments of the invention disclosed herein, the content database creation apparatus executes program instructions to create content on demand. In such an embodiment, the system may include an activation signal detector. The activation signal detector may be internal to or external to the content database creation apparatus. Upon receiving an activation signal, the system may execute program instructions to activate one or more other components of unit 120 and/or storage unit 121 and to generate one or more content elements according to at least one attribute value that is based on one or more previous attribute values, one or more user inputs, and/or one or more user profile information element. The one or more content elements may be stored in temporary memory or in permanent memory.

While the inventions disclosed herein have been described specifically for various embodiments of an educational content database creation, the inventions apply more broadly to the creation of other content databases. Examples of other content databases may include but are not limited to medical record databases, health content databases, listings content databases (for example for marketplaces like Airbnb, Uber, Zillow), manuals or other documentation databases, news or social media content databases, e-commerce product databases.

While the foregoing specification has detailed the process and apparatus for the creation of a content database, it should be appreciated that the disclosed methods and systems are equally applicable to the generation, management, and dissemination of individual content elements or a plurality thereof. Said content elements may be stored within a database environment for subsequent retrieval and use. Alternatively, these elements may be directly transmitted to a content delivery system, which is then responsible for rendering and delivering the content to a reviewer or end user (eg student).

### Systems and Methods for Automated Generation of Customized Educational Assessments Using Embeddings

One or more embodiments of the disclosure involve a system and method for generating customized educational assessments based on user/assessment creator's inputs and aligned with textbook content or educational curricula using embeddings. The system leverages embeddings, vectorized representations of the content, to understand the deep semantic meaning of both user/assessment creator's input criteria and educational content to facilitate the creation of assessments that are highly relevant and aligned with specific educational standards and materials.

Educational assessments play a crucial role in gauging student understanding and progress. However, creating assessments that are both personalized to individual teaching criteria and aligned with specific educational content and curricula can be time-consuming and challenging. An educational assessment is typically a set of one or more questions. An educational assessment may also include text such as, for example, an example, a reading passage, a text to be analyzed or translated, a primary source to be analyzed, a scientific experiment description, etc. Other examples are also possible. An assessment can be delivered as a quiz, a summative assessment, a regular test, an exam, a practice set, a homework assignment, etc. Other types of assessments are also possible. Assessments may take different forms and formats, and the form and format of an assessment may be important to align the assessment with a student's skills mastery and learning preferences.

The process for creating and storing embeddings for educational content and curricula may among other steps contain the steps of preprocessing, embedding generation, and embedding updating. Educational content and curricula may be stored in a content database. A content database may, among other content elements, include curriculum content elements, assessment content elements, or a combination of curriculum and assessment content elements. A content database my contain structured content elements, but it is also possible that the content database contains content in a variety of different formats. During preprocessing, educational content and curricula may be normalized (e.g. removing extraneous punctuation, standardizing terminology) to ensure consistency with the rest of the content database. The preprocessed content is passed through an embedding generator, which converts the content into vector representations. These vector representations facilitate semantic analysis. These vector representations (embeddings) are stored in association with their source content within the content database or in a separate database that is linked to the content database. Embeddings may optionally be periodically updated to reflect changes in educational content or improvements in embedding generation techniques. The system's matching engine compares the embeddings of user/assessment creator's inputs with those of the content database to identify the most relevant educational content and curricula. The output of the matching engine, the matched content may be sent to an assessment generation system, such as for example the content database creation system of FIG. 1C, and included as one or more attribute values in a Create request (128) that is sent to Content generator (122) to create customized questions and assessments, which are then presented to the user/assessment creator, or other consumers of the output, via one or more output interfaces.

Embodiments of this disclosure describe systems and methods for dynamically adjusting embeddings of educational content based on aggregated student performance data and real-time or near real-time feedback to generate customized educational assessments that are more closely aligned with student needs and learning outcomes. The disclosed systems and methods enhance the personalized learning experience by adapting the difficulty and relevance of educational content, thereby improving student engagement and understanding.

In one embodiment, a system includes a performance feedback loop. The system is configured to collect, aggregate, and analyze student performance data related to specific pieces of the educational content database. The performance data may include, but is not limited to, assessment scores, time spent on individual questions, rates of correct versus incorrect answers, and a student's or teacher's difficulty level or quality level rating. The system utilizes this data to identify patterns indicating for example the relative difficulty or case of the educational content for specific student groups.

Upon analyzing student performance data, the system dynamically adjusts the embeddings associated with the educational content. This adjustment does not alter the original textual content but modifies the high-dimensional vector representations (embeddings) to reflect inferred difficulty levels or other inferred metrics that predict optimal learning. For instance, if a substantial portion of students consistently performs poorly on questions derived from specific embeddings, indicating that the content may be too advanced, the system adjusts these embeddings to align with foundational concepts or prerequisites more closely. Dynamic adjustment of the embeddings may be applied to different types of content elements. Dynamic adjustments of the embeddings could for example be applied to instructional or assessment content elements to adjust the embeddings to match the knowledge or skill mastery level of specific student groups more closely. Dynamic adjustments of the embeddings could also be applied to instructional or assessment content elements to adjust the embeddings to match the learning style of specific student groups more closely.

The dynamic adjustment of embeddings can be achieved through various machine learning techniques, including but not limited to supervised learning, unsupervised learning, semi-supervised learning, reinforcement learning, and transfer learning. In case of transfer learning, the system may implement a process for retraining the embedding model on a subset of data labeled with difficulty levels derived from performance analysis. In case of reinforcement learning, the system may implement a reinforcement learning model that adjusts embeddings to maximize educational outcomes, using performance feedback as the reward signal. These techniques allow for fine-tuning of the model based on new data inputs, such as student performance metrics, to optimize educational outcomes. The system employs sophisticated algorithms to reposition content embeddings within the vector space, ensuring that the difficulty and focus of the educational material are dynamically aligned with the evolving needs and abilities of the student population.

Following the adjustment mechanism, whether manual or automated, embeddings for certain concepts are repositioned within the vector space. For instance, content deemed too advanced may be moved closer to vectors representing foundational concepts. Or in another example, assessments deemed requiring a too advanced level of comprehension and high-level thinking may be moved closer to vectors representing regurgitative or knowledge retention skills. In yet another example, it may be inferred that the test format is not optimal for the learning style of specific students or student groups, and assessments deemed having a too rigid structure (e.g. multiple-choice) may be moved closer to vectors representing assessment format that allow for more free form inputs. Other examples are also possible.

This repositioning does not modify the original content but alters the AI's interpretation of the content's complexity and relevance, ensuring that the educational material presented to students is appropriate for their current level of understanding. Leveraging these adjusted embeddings, the system is equipped to generate questions for new assessments that more accurately reflect learning objectives and/or align better with students' skill levels and learning styles. For example, if embeddings have been adjusted to indicate a simpler difficulty level, the system is predisposed to create questions that resonate with foundational knowledge, aligning with the system's objective to match content with the student group's understanding level.

Furthermore, the disclosed system may adapt the generation of embeddings from user (teacher or student, assessment generator or taker) inputs based on the aggregated performance feedback. This adaptation may involve modifying the parameters or context used in the embedding generation process to emphasize different aspects of the input, such as foundational knowledge over advanced topics, based on the collective performance data. This ensures that the assessments generated are better suited to the students' current understanding and learning context.

To facilitate the dynamic adjustment of embeddings, the system incorporates feedback mechanisms that can be direct, based on explicit performance metrics, or indirect, inferred from student interactions with the educational content. These mechanisms enable real-time adaptability of the system, ensuring that the educational content and assessments remain relevant and appropriately challenging.

Upon receiving user/assessment creator input, such as desired assessment types, grade levels, and specific curriculum standards, the input interface processes and translates these criteria into embeddings using a pre-trained language model. Concurrently, the content database maintains a dynamic repository of educational material embeddings, which are continuously updated to reflect both changes in the curriculum and adjustments based on aggregated student performance data. The system utilizes the dynamically adjusted embeddings to select matching content.

As a practical application scenario, consider the scenario where students consistently struggle with “Photosynthesis” in biology, suggesting the questions may be too advanced. Analyzing performance data, the system recognizes a gap in foundational knowledge related to “Cellular Respiration.” In response, the embeddings for “Photosynthesis” content are adjusted to be closer in vector space to “Cellular Respiration.” This adjustment indicates a prerequisite learning path, prompting the system to select content and subsequently generate assessments that reinforce “Cellular Respiration” understanding before advancing to more complex “Photosynthesis” questions.

FIG. 1D illustrates a high-level functional diagram of an adaptive system for the automated generation of customized educational assessments using embeddings in accordance with an example embodiment. The system comprises four interconnected subsystems: a content embeddings creation subsystem (1000), an assessment creation subsystem (1001), an assessment completion and storage subsystem (1002), and a embeddings optimizer subsystem (1003).

Content Embeddings Creation Subsystem (1000): Content without embeddings (1004) contains a compilation of educational materials. Content without embeddings (1004) may be stored in a database or other storage unit. This database or storage unit is functionally connected to a content embeddings creation subsystem (1000) which processes the educational materials to generate embeddings. A trained language model (1008) is employed by the content embeddings creation subsystem to produce high-dimensional vector representations of content, also referred to as embeddings. Content with embeddings (1005) may be accessed by or sent to assessment creation subsystem (1006) and used to create an assessment.

Assessment Creation Subsystem (1001): An assessment creation subsystem (1001) receives user/assessment creator input (1009), which specifies criteria for the generation of educational assessments. This subsystem interacts with a content database containing content embeddings (1005) to produce one or more assessments (1006) that correspond to the criteria derived from the user/assessment creator input. An assessment output (1006) may include, among other things, one or more questions, embeddings data defining the content from content database (1005) used for the assessment creation, and user/assessment creator input (1009)—possibly processed to normalize to a specific format or extract relevant components.

Assessment Delivery & Storage Subsystem (1002): Assessment completion and storage subsystem (1002) is configured to receive assessments from the assessment creation subsystem (1001), conduct any necessary further processing, and facilitate the delivery of these assessments to one or more assessment takers, such as students. Upon completion of the assessments by the takers, this subsystem is designed to collect and store a variety of data. This data encompasses the assessment information, which may include the questions or assessment itself, the embeddings utilized to create the assessment, and one or more assessment criteria provided by the user/assessment creator via user input 1009. In addition, demographic information pertaining to the assessment takers—such as grade level, school, class, ZIP code, gender, ethnicity, and other relevant demographic data—may be recorded. The subsystem also records one or more results of the assessments, which may comprise the takers' scores for individual questions, overall test scores, any notes or feedback provided by educators, etc. The data is stored within a database or a distributed system of interlinked databases. All or a subset of this data (1007) may be sent to or accessed by embeddings optimizer subsystem (1003) to retrain Language model (1008).

Embeddings Optimization Subsystem (1003): The system further includes an embeddings optimizer subsystem (1003). This subsystem utilizes performance data (1007) to adjust the embeddings within the content database dynamically.

The system allows for the iterative improvement of content embeddings to ensure continuous calibration and alignment of assessments with educational objectives and outcomes.

FIG. 1E is a schematic diagram illustrating an example embodiment of the content embeddings creation subsystem (1000) of FIG. 1D. Content Preprocessor (1020) receives educational content and performs initial processing tasks. The processing may include normalization of text or other multi-modal content, transcription of non-text content, removal of extraneous information or punctuations, converting of content to a standard structured data format, and other preparation of content for subsequent embeddings generation. The content preprocessor is designed to ensure that input content is in a standardized format suitable for embeddings generation.

Processed content (1031) is sent to or can be accessed by embeddings generator (1021). This component applies machine learning algorithms to the preprocessed content to create high-dimensional vector representations, known as embeddings. These embeddings capture the semantic significance of the educational content, facilitating the alignment of assessment questions with educational standards and objectives. Embeddings generator (1021) serves as a specialized processor for converting preprocessed educational content into embeddings. This component is designed to implement machine learning algorithms and utilize pre-trained language models for generating vectorized representations of text and/or multimodal data. Embeddings Generator (1021) accepts normalized and standardized educational content from the Content Preprocessor (1020). This input is typically in the form of textual data, which may include metadata for multi-modal content, structured to align with the format and structure of the system's content database (1028). To create embeddings for educational content input (1031), embeddings generator (1021) uses one or more machine learning models, capable of handling a variety of data types and structures and optimized for natural language understanding. The models are trained to capture the semantic nuances and contextual relevance of the educational content. The output of embeddings generator (1021) is a set of high-dimensional vector representations, or embeddings (1032). Each vector is a point in an n-dimensional space where ‘n’ is determined by the model architecture. These embeddings capture the essential semantic features of the input content, enabling effective matching and retrieval based on semantic similarity. Embeddings generator (1021) uses one or more pre-trained language models (1033) that have been exposed to extensive corpuses of educational text. These models facilitate the understanding of complex language structures and the extraction of semantic meaning, ensuring that the generated embeddings are representative of the content's educational significance. In translating educational content into embeddings, embeddings generator (1021) may encode multiple facets including but not limited to grade level, difficulty level, applicable educational standards criteria, etc. While not performing the matching operation itself, the embeddings generator (1021) constructs embeddings in a manner that is conducive to cosine similarity measures, enabling effective downstream matching processes to identify content that aligns with user-defined criteria. Upon generating the embeddings, embeddings generator (1021) interfaces with content database updater (1022) to ensure that the newly generated embeddings are appropriately integrated into content database (1028) for use in the assessment creation process.

Components of the content embeddings creation subsystem illustrated in FIG. 1E may be be implemented in hardware, software, or a combination of hardware and software. For example, a hardware implementation of embeddings generator (1021) may involve utilizing dedicated neural processing units (NPUs) that are specifically designed for accelerated machine learning tasks. These NPUs can be part of application-specific integrated circuits (ASICs) or field-programmable gate arrays (FPGAs) that provide the computational efficiency and speed required for processing large volumes of educational data and generating embeddings in real-time. The hardware may also include high-speed memory modules, such as DDR SDRAM, to facilitate rapid data access and throughput. A software implementation of embeddings generator (1021) may comprise a set of machine learning algorithms encoded as software modules. These modules may be written in high-performance programming languages such as C++ or Python and utilize machine learning libraries and frameworks like TensorFlow or PyTorch. The software may be designed to be deployed on general-purpose computing systems, ranging from single-board computers for prototyping to enterprise-grade servers for production environments. Embeddings generator's software components may be optimized to run on the aforementioned hardware with specific considerations for parallel processing capabilities, such as utilizing multi-threading and vectorized operations. When running on NPUs, the software may leverage the hardware's specialized instruction sets designed for tensor operations, fundamental to machine learning computations. Embeddings generator (1021) may be integrated into the system's larger infrastructure via system buses or network interfaces, allowing it to communicate with other system components, such as content preprocessor (1020) and content database updater (1022). The integration supports data transfer protocols and formats that enable efficient transmission of preprocessed data to embeddings generator (1021) and the resulting embeddings to subsequent system components.

The system shown in FIG. 1E also includes memory access controllers (1029, 1027) which manages access to corresponding storage units (1020, 1028). Memory access controller (1029) manages access to a storage unit (1030) that retains raw educational content, or content without embeddings. It serves as an interface between content preprocessor (1020) and storage unit (103), facilitating the retrieval and storage of raw educational content). Memory access controller (1024) manages access to a second storage unit (1028) which stores educational content in a structured data format with embeddings. It interfaces with the content database updater (1022), managing the storage and retrieval of structured content that has been processed to include embeddings.

FIG. 1F one example embodiment of assessment creation subsystem (1001) as referenced in FIG. 1D, showing the technical flow from user/assessment creator input through the assessment generation. User interface (1040) may be a portal through which the user/assessment creator interacts with the system. It is engineered to accept a variety of assessment criteria from the user/assessment creator. Assessment criteria may among other things include one or more of the following: grade level, assessment type (open-book, closed-book, etc), question types (multiple-choice, short-answer, fill-in-the-blanks, etc), textbook and/or curricula used for instruction, applicable educational standards, language, subject (history, English Language Arts, social studies, etc). User Input Preprocessor (1041) receives user/assessment creator input (1045) and performs the necessary processing tasks. Processing may among other things include normalization of text, transcription of multi-modal content, removal of extraneous information or punctuations, converting of content to a standard structured data format that is suitable for processing by embeddings generator (1042) and assessment generator (1044).

Content Preprocessor (1020) receives educational content and performs initial processing tasks. The processing may include normalization of text or other multi-modal content, transcription of non-text content, removal of extraneous information or punctuations, converting of content to a standard structured data format, and other preparation of content for subsequent embeddings generation. The content preprocessor is designed to ensure that input content is in a standardized format suitable for embeddings generation. Embeddings Generator (1042) receives the standardized user/assessment creator input from preprocessor (1041) and employs one or more machine learning algorithms to translate this input into semantic embeddings. These embeddings are high-dimensional vector representations that capture the deep semantic meanings intended by the user/assessment creator's input criteria. The generator utilizes pre-trained language models, which have been exposed to extensive educational content, to ensure the embeddings are contextually accurate and semantically rich.

Matching engine (1043) uses as semantically encoded user/assessment creator inputs available as embeddings (1046) and semantically encoded content available as embeddings (1050) and performs one or more search operations for the most semantically similar content within the content database. The engine's core functionality is to analyze and compare the semantic embeddings of user/assessment creator inputs with those of the educational content to find the most relevant match. Matching engine (1043) may use cosine similarity measures to scan the embedding space, comparing user/assessment creator input embeddings to content embeddings and identifying educational content with the closest match to the user-defined criteria. The matching process ensures that the resulting assessments are personalized and accurately tailored to the educational standards and objectives specified by the user/assessment creator.

Cosine similarity is a sophisticated technique widely recognized in natural language processing and information retrieval domains. Cosine similarity provides a metric for assessing the cosine of the angle between two vectors in the n-dimensional space, which in this context are the embeddings of the user/assessment creator input and the educational content. The similarity score generated by this measure ranges from −1 to 1, where a score of 1 denotes identical orientation, indicating maximum similarity.

This metric is particularly adept at capturing the nuanced semantic relationships between the assessment criteria specified by the user/assessment creator and the potential content within the database. By evaluating the cosine similarity, matching engine (1043) can determine the degree of alignment between the user/assessment creator's requirements and available educational resources with a high degree of accuracy. Other measures to determine semantic similarities are also possible.

The output of the matching engine (1043) is a selection of educational content that closely corresponds to the user/assessment creator's input criteria. Output (1048) of matching engine (1043) may be formatted to facilitate the downstream processing by the assessment generator (1044) and may include one or more of the following components: (1) matched content metadata: A list of identifiers for the educational content within the content database that has been identified as a match. This metadata enables the Assessment Generator (1044) to retrieve the full content records for assessment construction, (2) semantic similarity scores: Accompanying each matched content identifier, a semantic similarity score may be provided, quantifying the degree of relevance to the user/assessment creator's criteria based on the cosine similarity metric, (3) embedding vectors: For each piece of matched content, the corresponding embedding vectors are included. These high-dimensional vectors represent the semantic features that aligned with the user/assessment creator's input embedding, (4) Content summaries: A concise summary or an abstract of the matched content, (4) Relevant criteria tags: Tags or keywords derived from the user/assessment creator's input criteria that have been identified as relevant in the matching process. These tags may serve as a reference to ensure that the generated assessment maintains alignment with the specified criteria.

The output format is designed to be machine-readable for automated processing by the Assessment Generator (1044). It may also be designed to be human-readable for possible review or manual adjustment by the user/assessment creator. The data may be structured in a JSON (JavaScript Object Notation) format, XML (extensible Markup Language), or another structured data format that is compatible with the system's assessment generation protocols.

Assessment generator (1044) may be activated upon the successful matching of content, but other triggers for activation of assessment generator (1044) are also possible. Assessment generator (1044) utilizes one or more outputs from matching engine (1043), one or more user assessment criteria (1050), and possibly other inputs to construct an assessment.

In one specific embodiment, the content database creation system of FIG. 1C or a subset of components of the content database creation system shown in FIG. 1C is used to create an assessment based on matched content (1048) and user assessment criteria inputs (1050).

FIG. 1G illustrates an example embodiment of an assessment generator component (1044) as part of an automated system for generating educational assessments. The assessment generator component (1060) is responsible for constructing assessments that are tailored to user/assessment creator input and semantically matched content.

The assessment generator component (1060) may be implemented through a combination of hardware circuitry and program instructions executed by a general-purpose processor. The apparatus includes several integral components such as an attributes generator (1061), a prompts generator (1062), a create request generator (1070), a content response processor (1064), and interfaces for memory access and storage components (not depicted in FIG. 1G).

The attributes generator (1061) processes matched content (1073) received from a matching engine (1043), using program instructions to extract and convert this content into a set of one or more attributes (1072). The attributes generator (1061) uses a general-purpose processor to execute program instructions that define a set of attribute values (1072) necessary for constructing one or more assessments. Attributes generator may use the output of matching engine (1043) to look up and extract semantically matched content from content database 1028. The extracted semantically matched content may be assigned as an attribute value to an attribute key. Attributes generator (1061) may further process one or more assessment criteria inputs from the user input (1074) to create additional attribute key-value pairs. They attributes may include, for example, the difficulty level, question format, subject area, and grade level of the intended assessment. The attributes generator (1061) may also feature an attribute modifier, which adapts attribute values to generate a refined set of attributes for subsequent assessments.

The prompts generator (1062) employs program instructions to generate or select prompts (1071) that will be used to solicit content from the content generator (1065). These prompts are derived from a database or list of potential prompts, which may be stored in memory and accessed via a memory access controller, based on user input (1075).

The create request generator (1070) is tasked with sending create requests (1069), including the selected prompts and attributes derived from matched content and user inputs to the content generator (1065) to initiate the generation of assessment content. The content generator (1065) may be a separate AI-based model capable of creating content through generative techniques, potentially located externally to the assessment generator apparatus. Content generator 1065 may, for example, use Large Language Models to create content.

The content response processor (1064) receives content responses (1068) from the content generator (1065) and processes this information to extract specific data relevant to the assessment construction and generate and format an assessment (1066). Content response processor (1064) may interact with memory to store the processed content temporarily or permanently.

Assessment generator component (1060) and content response processor (1064) may communicate with external content generator (1065) of an application specific interface (API) (1067).

Assessment generator component (1060) is configured to operate in conjunction with matched content (1074), which has been identified by the matching engine (1043) as relevant to the user/assessment creator's criteria. The component utilizes the matched content to inform at least one attribute value, ensuring that assessment (1066) are closely aligned with the educational objectives and the needs of the end user (eg student).

The overall process may involve iterative interactions between the components, with the create request generator (1070) potentially initiating additional create requests based on the responses received and the ongoing refinement of attributes and prompts, leading to a dynamic and responsive assessment creation process.

In specific embodiments, the assessment generator component (1060) may be adapted to include end user-specific (eg student-specific) or group-specific attribute values, allowing for the generation of personalized assessments. These assessments can be stored in a dedicated end user or group-specific database or delivered directly through a user interface to the assessment creator, a reviewer or an end user.

Assessment generator component (1060) may include an activation mechanism that, upon receiving a signal, triggers the components to generate one or more assessments based on a combination of user inputs, matched content, and predefined or dynamically generated attributes. These assessments may be stored in various formats, including, but not limited to, JSON objects, and may be tagged with metadata for easy retrieval and identification.

FIG. 1H illustrates an example embodiment of embeddings optimizer subsystem (1003) as referenced in FIG. 1D. Performance data processor (1080) receives performance data (1085) from an assessment storage subsystem. This data encompasses, possibly among other information, one or more of the following: (1) assessment-specific information, such as, for example, matched content metadata, semantic similarity scores, embedding vectors for matched content, content summaries, and relevant criteria tags, (2) information pertaining to the assessment takers—such as grade level, school, class, ZIP code, gender, ethnicity, and other relevant demographic data, (3) performance metrics, such as, for example, assessment scores, the time allocated to individual questions, to score for individual questions, and the frequency of correct versus incorrect response. Performance data processor (1080) is tasked with aggregating and analyzing the received data to discern patterns that may indicate the relative difficulty or case of the educational content for certain student groups. Performance data processor (1080) may further create a labeled dataset with labels derived from the analysis of the performance data and communicate over interface (1087) with memory access controller (1089) of storage unit (1081) to store the labeled dataset in performance data database (1088).

Embeddings model optimizer (1082) communicates over interface (1084) with memory access controller (1089) of storage unit (1088) to retrieve labeled dataset, or a portion thereof, from performance data database (1088) and uses the retrieved dataset to generate a retrained embeddings model (1083). The retrained embeddings model (1083) therefor takes into account difficulty levels inferred from student performance data. Embeddings model optimizer (1082) may use a variety of machine learning techniques, such as transfer learning and reinforcement learning, to generate a retrained embeddings model that can then be used in an automated, adaptive assessment generation system to fine-tune the high-dimensional vector representations of content.

In example embodiments, embeddings optimizer subsystem (1003) may take as an input one or more identifiers for a specific student or specific student group, analyze performance data (1007) related to said specific student or specific student group, analyze performance data from other students or student groups, possibly using a different set of identifiers, comparing the performance analysis results of the target group to the performance analysis results of the other group(s), and retrain the embeddings model to improve or optimize the alignment of the embeddings with the skills and/or learning styles of the target group. A system may generate and store different embeddings models for different groups.

In one specific embodiment, the output of a performance data processor may also be used to modify one or more other attribute values. For example, if it is determined that a specific test format better supports the learning of a students' group, the test format attribute value may be changed to that test format, or otherwise be modified to include that test format or put a higher weight on that test format.

In one example embodiment, a database of content elements with embeddings is used in an assessment system to assess students' knowledge and/or comprehension against instructional content elements using assessment content elements. Instructional content and assessment content elements may be vectorized using embeddings. Assessment content elements may be vectorized based on, among other criteria, content, difficulty level, and assessment modality. Examples of assessment modality may include but are not limited to type of questions, sequence of questions, length of test, test delivery method (paper, online, audio, oral, interactive video, gamified, etc). An embeddings optimizer may be used to optimize the instructional content and/or assessment content embeddings for a specific student group. The content database with optimized embeddings may be used to generate one or more assessments customized for a specific student group.

### Systems and Methods for Real-Time Interactive Tutoring

The system and methods included herein may further be directed towards a method and apparatus for an interactive tutoring system that provides real-time personalized feedback to a user (eg student) on their answer to skills-assessment prompt. The skills-assessment prompt may for example be in the format of a practice problem, a test question, or a writing prompt. Other formats are also possible. The skills-assessment prompt may for example be a multiple-choice question, an open-ended question, a free-form question, or a fill-in-the-blanks question, but other formats are also possible.

The system evaluates a user's answer and utilizes an interface to at least one artificial intelligence (AI) model to generate feedback on the user's answer, wherein feedback may include but is not limited to one or more of the following: an explanation of why the user's answer is correct or incorrect, one or more suggestions on how to correct or improve the user's answer. The AI model may be a generative or computational AI model, but other AI models are also possible.

The system may further include a questions-and-answers module that allows a user to ask follow-on questions or clarifications. The questions-and answers module may use the same or a different interface to the same or different AI models to generate additional explanations.

Evaluating a user's answer may comprise of determining a reference answer and comparing the user's answer to said reference answer. Determining a reference answer may be done at the time of creation of the educational content database, at or around the time when the user answers the skills-assessment prompt, or at a different time.

To determine a reference answer, the system may use the same interface to the same AI model as it uses to request feedback. Alternatively, it may use a different interface, a different AI model, or a different method altogether. For example, the system may have a user interface that allows an authority such as a subject matter expert, an educator, an administrator, or a parent to manually enter a reference answer. In yet another example embodiment, the reference answer may be programmatically configured in software. In yet another example embodiment, the reference answer may be obtained by crowd sourcing, where responses from multiple people or sources are obtained, optionally weighed for importance, and deterministic or probabilistic methods are used to determine the reference answer from one or more crowd-sourced responses. A reference answer may be stored in the educational content database alongside the skills-assessment prompt.

In one set of embodiments of the invention disclosed herein, determining a reference answer may be implied. For example, upon receiving a user's response to a skills-assessment question, the system may interface to a computational or generational AI system to request feedback on the user's answer without providing an explicit reference answer. In this example, the system assumes that the content generator is able to determine a reference answer, or has other ways to evaluate the user's answer, without supplying it explicitly with a reference answer.

In various embodiments of the invention disclosed herein, the system receives a user's answer, determines a reference answer, and compares the two to determine correctness of the user's answer. The system may use an interface to one or more AI models to perform the correctness assessment. The system may request an explanation from one or more AI models as to why the answer is correct or incorrect. The request for an explanation may be included with the request to assess the correctness of the answer. Alternatively, it may be sent separately over the same or over a different interface. It is possible that the system requests and explanation from one or more AI models without first performing a correctness assessment or regardless of the outcome of the correctness assessment.

In specific embodiments of the invention, the explanation process may involve defining at least one prompt to request, possibly among other requests, an explanation for why the user's answer is correct or incorrect; sending an explanation request over the interface, wherein an explanation request may include, among other things, at least one of the following: a prompt, the skills-assessment prompt, the user's response, the correct answer to the skills-assessment prompt, or an example answer; receiving an explanation response over the interface, wherein the explanation response may include an explanation element; processing the explanation response or element to extract or derive explanation-specific content; and rendering explanation-specific content to the user.

In specific embodiments of the invention, the explanation request is formatted to interact with a conversational or natural language-based AI system and may include attributes specifying desired characteristics, format type, format characteristics of the explanation element or response, additional context, approved or recommended sources to use, and format templates or examples in the desired format. The explanation response is received and processed to extract or derive the explanation-specific content, which is then rendered to the user using one or more display methods such as a display, voice assistant, a speaker, headphones, or voice-enabled avatar.

Desired characteristics of the explanation element may for example include the difficulty level, style, tone, or length indications. Other examples of characteristics are also possible. The format type of the explanation element may include written text, speech, video, doodle, or presentation format. Other formats are also possible. The format characteristics of the explanation element may include language, response syntax, use of specific tags, capitalization or punctuation, test format (eg open-ended, fill-in-the-blanks, multiple choice), maximum length or duration, font size, maximum number of words per slide, voice tone, voice emotion, pace, accentuation of specific words or phrases, difficulty level of vocabulary, grammar, or sentence construction. Other examples of format characteristics are also possible.

The system may also provide suggestions for improvement, in a similar manner to the explanation for incorrect answers, by sending a request for an explanation of how the user's answer can be improved.

In one set of embodiments of the invention disclosed herein, the steps of receiving a user's answer, sending an assessment request (if applicable to the specific embodiment), receiving an assessment response (if applicable to the specific embodiment), processing the assessment response to determine if further explanation is needed (if applicable to the specific embodiment), and if so, sending an explanation request, receiving an explanation response, processing the explanation response to extract explanation-specific content, and rendering the explanation to the user are performed in real-time or near real-time. The further steps of receiving a follow-on question about the explanation, sending an explanation request, receiving an explanation response, processing the explanation response to extract explanation-specific content related to the follow-on question, and rendering the explanation-specific content to the user may also performed in real-time or near real-time.

The user may also ask follow-on questions on the explanation-specific content. The system allows the user to ask at least one follow-on question and defines a prompt to request an answer to the follow-on question. The explanation request is sent over the interface and the explanation response is received, processed to extract or derive explanation-specific content, and rendered to the user in the same manner as described for the explanation for incorrect answers.

The invention is particularly useful for online education platforms, allowing for personalized feedback and guidance to students in real-time. The system is adaptable to various types of questions, including multiple-choice, open-ended, and free form questions, and is capable of rendering feedback in a variety of formats, including written text, speech, video, and more. The system provides a more personalized and engaging educational experience, leveraging the capabilities of AI to provide tailored and interactive feedback to students.

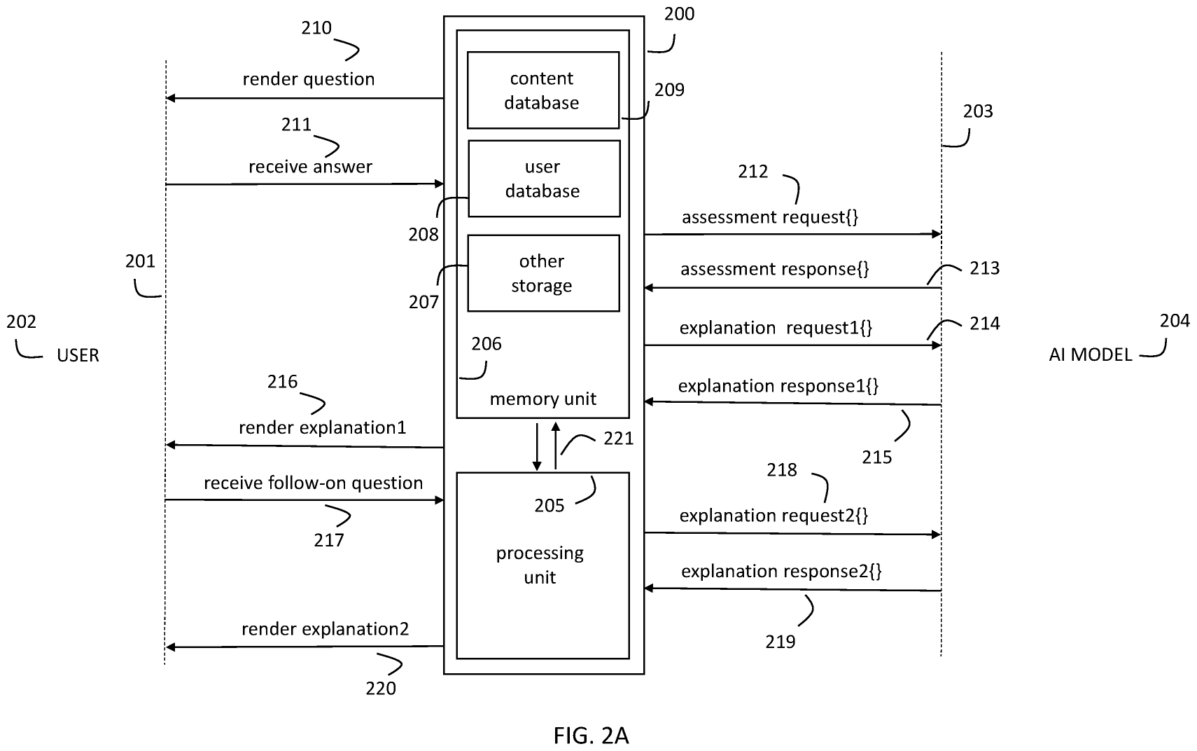

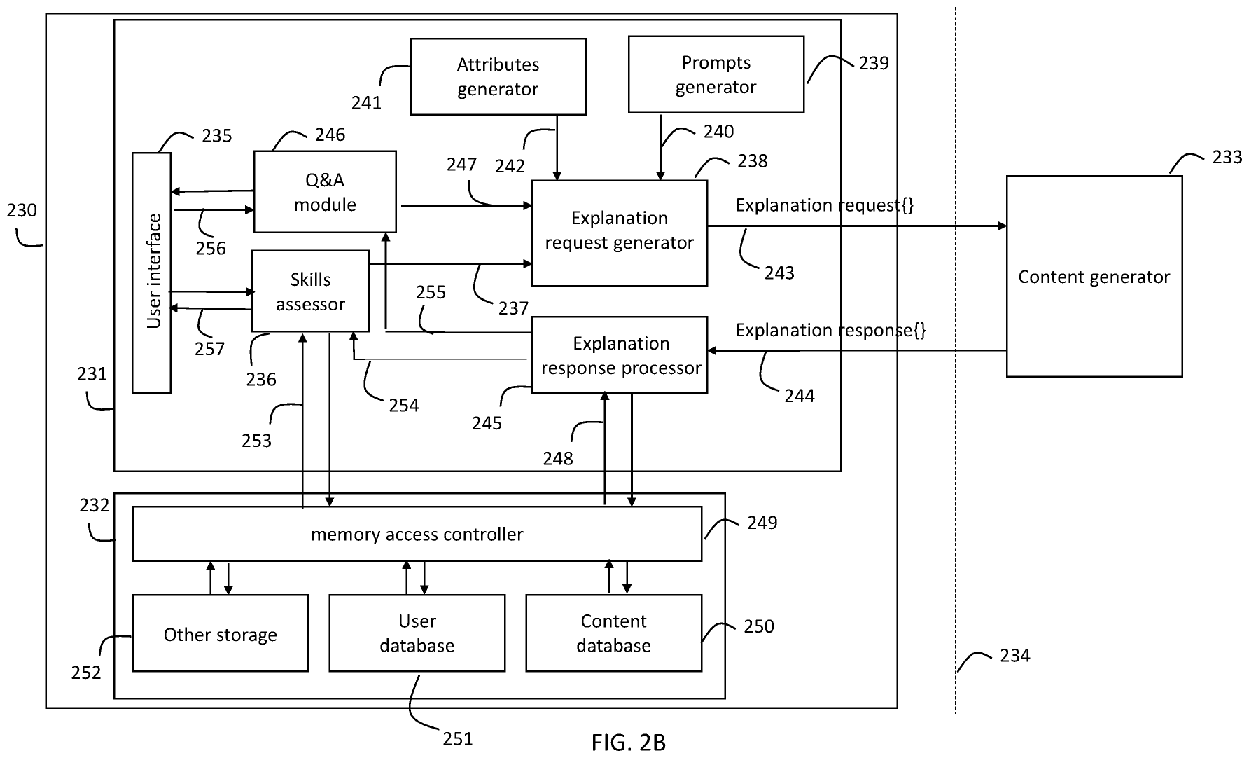

An embodiment of an interactive tutoring system, according to various embodiments of the invention is illustrated in FIG. 2A. The interactive tutoring system 200 includes a processing unit 205, a storage unit 206, and a user interface 201. The storage unit 206 may include various components such as an educational content database 209, a user database 208, and other temporary or permanent storage 207. User database 208 may be used to store user-specific data such as for example status, progress, results from assignments or assessments, user profile information.

The user interface 201 is used to communicate with a user 202 to request information from the user or to provide information to the user 202. The interactive tutoring system 200 also communicates with an AI model 204 through an interface 203, which may be a natural-language based AI interface.

In operation, the interactive tutoring system 200 uses the processing unit 205 and possibly one or more data stored in the memory unit 206 to select a skills-assessment prompt from the educational content database 209. The skills-assessment prompt 210 is then rendered to the user 202 through the user interface 201. The user 202 responds to the skills-assessment prompt, and the response 211 is received by the interactive tutoring system 200 and processed by the processing unit 205. The user's response may be stored in the user database 208.

The interactive tutoring system 200 may create an assessment request 212 using the processing unit 205 and the user's response 211. The assessment request 212 may among other things and possibly in a modified format, include a prompt to request an assessment of the user's response, the original skills-assessment prompt 210, the user's response 211, and additional attributes that specify the expected format and characteristics of the assessment response.

The assessment request 212 is sent to the AI model 204 through the interface 203, and the AI model 204 returns an assessment response 213. The assessment response may, among other things, include a correctness assessment in the requested format and with the requested characteristics, and optionally a reference answer.

The interactive tutoring system 200 processes the assessment response 213 using processing unit 205 to determine if additional explanation is necessary. If additional explanation is deemed necessary, the interactive tutoring system 200 sends an explanation request 214 to the AI model 204 through interface 203. Explanation request 214 may, among other things and possibly in modified format, include a prompt with request for explanation of the correctness assessment, the original skills-assessment prompt 210, the user's response 211, the reference answer, the received correctness assessment, and additional attributes that specify the expected format and characteristics of the explanation response 215.

Upon receipt of the explanation response 215, the interactive tutoring system 200 may process the explanation-specific information using processing unit 205 and render the explanation-specific content 216 to the user 202 through the user interface 201. The explanation-specific information may also be stored in the storage unit 206.

The user 202 may request additional clarification or explanation by submitting a follow-on question 217. The interactive tutoring system 200 may process the follow-on question 217 and send an explanation request 218 to the AI model 204 if additional explanation is deemed necessary. The explanation request 218 may, among other things and possibly in modified format, include one or more of the following: a request for further explanation of the correctness assessment, the original skills-assessment prompt 210, the user's response 211, the reference answer, the correctness assessment, the explanation-specific response 216, the user's follow-on question 217, and additional attributes that specify the expected format and characteristics of the explanation response 219.

Upon receipt of the explanation response 219, the interactive tutoring system 200 processes the explanation-specific information using processing unit 205 and renders the explanation 220 to the user 202 through the user interface 201. The explanation-specific information may also be stored in the memory 206.

A specific example of the embodiment is an online learning platform for teaching reading comprehension to middle school students. The platform utilizes a conversational AI model to provide personalized feedback on the students' answers to reading comprehension questions. The platform can present the questions in multiple-choice, open-ended, or free-form formats.

In various embodiments of the invention, the interactive tutoring system may communicate with one or more content generators that use computational or generative AI models to generate explanation-specific content related to the user's answer.

The content generator(s) may be implemented by hardware circuitry, by program instructions that are executed by a general-purpose or special-purpose processor, or by a combination of both. For example, the AI model may be implemented as a set of program instructions that are executed on a central server, utilizing one or more processors and one or storage units in the central server.

The AI-based content generator may be external to the interactive tutoring system and may be communicatively coupled to the interactive tutoring system. It is also possible that the AI-based content generator is embedded within the interactive tutoring system or that certain components of the AI-based content generator are external to the interactive tutoring system and other components are internal.

In various embodiments of the invention, methods and systems described in this disclosure may be implemented as a set of program instructions that can be stored in memory and that can be executed by a general-purpose or special-purpose processor on an electronic device such as a laptop or mobile phone, or on a central server.

FIG. 2B is a block diagram illustrating an example embodiment of various inventions disclosed herein. It should be noted that for simplicity and clarity reasons not all connections between components are shown. For example, attributes generator 241 and prompts generator 239 may interact with memory 232 or components within memory 232 to store or retrieve data, but those connections are not shown for simplicity and clarity reasons.

Functional components of the interactive tutoring apparatus 230 may be implemented by hardware circuitry, by program instructions that are executed by a general-purpose processor, or by a combination of both. Where it is indicated that a processor does something, it may be that the processor does that thing as a consequence of executing instructions read from an instruction memory wherein the instructions provide for performing that thing. Where it is described that a processor performs a particular process, it may be that part of that process is done separately from the electronic device, in a distributed processing fashion. Thus, a description of a process performed by a processor of the electronic device need not be limited to a processor within the electronic device, but perhaps a processor in a support device that is in communication with the electronic device.

One or more functional components may make use of one or more processing units and one or more memory units on the electronic device or on the server. The system implementation can also be distributed, with some program instructions executed on a processor in a central server and others executed locally on a processor in the user's computing device.

The components of the apparatus may include but are not limited to one or more of the following: a user interface 235, a skills assessor 236, a prompts generator 239, an attributes generator 241, an explanation request generator 238, an explanation response processor 245, a Q&A module 246, a memory access controller 249, and one or more storage components such as for example content database 250, user database 251, and other temporary or permanent storage 252.

Skills assessor 236 may use a general-purpose processor to execute program instructions to select a skills-assessment prompt and render said skills-assessment prompt to the user through user interface 235. Skills assessor 236 may use interface 253 to memory access controller 249 to retrieve data from memory. For example, skills-assessment prompts may be stored in content database 250 and skills assessor 236 may use one or more pointers or indices to identify or select a skills-assessment prompt from the database. Skills assessor 236 may also access memory 232 for other reasons, such as for example to retrieve user-specific information or historical data from the user.

Skills assessor 236 may further use a general-purpose processor to execute program instructions to retrieve a user's answer to the rendered skills-assessment prompt through user interface 235, activate a reference component to determine or retrieve one or more reference answers, evaluate the user's answer based on the one or more reference answers, determine if an explanation is required, and if so send a signal 237 to explanation request generator 238 to power up or activate, as needed, any circuitry or components necessary to execute the explanation request process, and initiate the explanation request process. Skills assessor 236 may use an interface to an AI model to determine a reference answer and/or evaluate a user's answer, but other methods are also possible.

The AI-based content generator 233 may be external to the interactive tutoring system 230 and may be communicatively coupled to the interactive tutoring system 230. It is also possible that the AI-based content generator is embedded within the interactive tutoring system or that certain components of the AI-based content generator are external to the interactive tutoring system and other components are internal.

The interactive tutoring apparatus 230 may also include a Q&A module 246 that communicates with user over user interface 235 and allows the user, after receiving an explanation, to ask one or more follow-on questions. Upon receiving a follow-on question 256, Q&A module 246 may use a general-purpose processor to execute program instructions to process the follow-on question and send a signal 247, including portions or all of the follow-on question, to explanation request generator 238 to power up or otherwise activate as needed any circuitry or hardware required for executing the explanation request process, and to initiate the explanation request process.

Prompts generator 239 may use a general-purpose processor to execute program instructions to generate or select one or more prompts 240 used to query content generator 233. A list, array, or database of prompts may be stored in memory 232 (e.g. in other storage component 252) and prompts generator 239 may use one or more pointers or indices to identify one or more relevant prompts from the list, array, or database of prompts or otherwise access the list, array, or database of prompts for example through memory access controller 249.

Attributes generator 241 may use a general-purpose processor to execute program instructions to define a set of attribute values 242 used to specify one or more parameters of the explanation. Examples of attributes include but are not limited to characteristics of the explanation element such as for example language, difficulty level, style, tone, or one or more length indications; format type of the explanation element such as for example written text, speech, video, doodle, presentation; format characteristics of the explanation element such as for example font size, maximum number of words per slide, voice tone, voice emotion, pace, accentuation of specific words or phrases, syntax of response, use of specific tags, capitalization or punctuation; approved or recommended sources to use; a format template or one or more example explanations implemented in the desirable format; or attributes specifying additional context.

The list(s), array(s), or JSON object(s) of all attributes may be stored in memory 232 (e.g. in other storage component 252) and attributes generator 124 may use one or more indices or pointers to identify one or more relevant attribute values from the list(s), array(s), or JSON object(s) of attributes or otherwise access list(s), array(s), or JSON object(s) for example through memory access controller 249.

Upon receiving a signal 237 from skills assessor 236 or a signal 247 from Q&A module 246, explanation request generator 238 may execute a set of program instructions to send one or more explanation requests 243, including one or more prompts 240 and/or attributes 242, to content generator 233 through AI interface 234 to generate an explanation element. Content generator 233 may use one or more computational or generative AI models to generate the requested explanation element. Content generator(s) 233 may be implemented as software, hardware, or a combination of both. For example, the AI model may be implemented by hardware circuitry, by program instructions that are executed by a general-purpose or a special-purpose processor, or by a combination of both.

Explanation response processor 245 may receive the one or more explanation responses 244 and may execute program instructions to processes them to extract one or more explanation elements.

The one or more explanation elements may be stored in memory 232 (e.g. in temporary or permanent memory in other storage component 252). The explanation response processor may use interface 248 to memory access controller 249 to store one or more explanation elements. They may be stored in temporary memory or in permanent memory. Alternatively, or in addition, the one or more explanation elements may also be further processed and sent to skills assessor 236 or Q&A module 246 to be rendered to the user through user interface 235. In other embodiments of the invention, explanation response processor 245 may communicate directly with user through user interface 235. Other variants are also possible.

### Systems and Methods for Automated Grading

In various embodiments of the invention, a method and apparatus for a grading system is disclosed that assesses a user's level of mastery and grades a user's skill such as for example their comprehension, critical thinking, or writing skill using an interface to at least one AI system. Other skills are of course also possible. The AI system may be a computational or generative AI system, but other AI-based systems are also possible. The AI system may be general purpose or special purpose. The AI system may be external or internal to the grading system.

The grading system includes a user interface for retrieving a user's response to one or more mastery-assessment prompts such as for example a comprehension, critical thinking, or writing question or prompt. Other kinds of mastery-assessment prompts are also possible. The grading system may present the user with a single mastery-assessment prompt or with a series of mastery-assessment prompts and process the one or the series of user's response(s) to the prompt(s). The series of prompts may be presented to the user one at a time, a subset at a time, or all at once. The user's responses may be processed one at a time, a subset at a time, or all at once after the user has submitted all mastery-assessment prompts.

The grading system may access an interface to an AI-based system and communicate one or more of the user's responses to said AI-based system to generate a user's grade. The grading system may further access and interface to an AI-based system to generate feedback on the correctness or quality of one or more responses and/or additional information that clarifies why the user received a certain grade.

The grading system may create a set of attributes for one or more grading requests. These attributes may among other things specify the grading criteria, the requested format of the grading response (such as language, syntax, use of specific tags, capitalization or punctuation, maximum length, etc.), approved or recommended sources to use, examples with labeled grading values, and additional context.

The grading system may define or select at least one prompt to request, from a computational or generative AI system, a grade for one or a set of user responses, and sends one or more grading requests over the interface, which may include the mastery-assessment prompt(s), the user's response(s), the prompt and/or one or more attributes. A single grading requests may be sent to request grading of multiple responses. Alternatively, a grading request may be sent for each user response separately

The grading system receives at least one grading response over the interface and processes the response(s) to extract or derive the grade-specific content (eg in the format of one or more grade-specific elements). The grading response(s) may include one or more of the following: a grade per user response, an overall grade, clarification on why a certain grade was assigned, additional feedback or explanations on the correctness of the user's response, and feedback on the quality of the user's response.

In further embodiments, the grading system may store the grade-specific content/element(s) in memory, render the grade-specific content/element(s) to the user, or send it to an authority such as for example an administrator, an educator, or a parent.

In various embodiments of the invention disclosed herein, the grading system may present a user with a series of mastery-assessment prompts, and for each mastery-assessment prompt receive a user response, process the user response to create a grade request, send the grade request of the interface to an AI model, receive a grade response from the AI model, process the grade response to extract or derive grade-specific content/element(s). The system may further process the grade-specific content/element(s) from all or a subset of the grading responses to determine an overall grade, store the overall grade in memory, render the overall grade to the user, or send the overall grade to an authority such as for example an administrator, educator, or parent.

In various embodiments of the invention disclosed herein, some or all of the steps of presenting one or more mastery-assessment prompts to the user, receiving the user's answers to the one of more responses, processing the answers to create one or more grade requests, sending one or more grade requests over an interface to an AI-based system, having the AI-based system assess the one or more user's responses and assign a grade, receiving a grade response from the AI-based system, and processing the grade response to extract grade-specific information, may be done in real time or near real-time. The additional steps of further processing grade-specific information and rendering grade information to a user or to a third-party authority may also be done in real time or near real-time.

Additionally, the system may allow a user to ask one or more follow-on questions about the received grade and receive explanations that answers their questions, submit one or more test corrections, have the one or more test corrections graded, and/or collect and calibrate or normalize grade responses across a group of users.

In one set of embodiments of the invention, the method and apparatus for a grading system further provides a feature allowing a user to ask follow-on questions on the grade-specific content. The grading system includes a user interface for retrieving one or more user's follow-on questions related to the grade-specific content.

The system defines at least one prompt to request an answer to the user's follow-on question(s). The system sends an explanation request over the interface to the AI model. The explanation request may include, among other things, the prompt and any other necessary information such as for example the user's follow-on question, the original mastery-assessment prompt, the original user's response, the original returned grade. The system receives an explanation response over the interface and processes the response to extract or derive the explanation-specific content. The system renders the explanation-specific content to the user through a user interface. This feature helps improve the user's understanding of their grades or their mistakes and enables them to ask for personalized clarification on the specific items or skills assessed.

The additional steps of allowing a user to ask one or more follow-on questions and providing the users with personalized answers to those questions to enhance their learning may be done in real time or near real time.

In one set of embodiments of the invention, the method and apparatus for a grading system further provides a feature allowing a user to submit a second attempt or a test correction through a user interface. The system may present the same, a similar, or otherwise equivalent mastery-assessment prompt to the user when the user starts the second attempts or test correction. The system may grade the user's response for the second attempt or test correction using the grading methods described elsewhere herein. The system may further process the original grade and the grade from the test correction or second attempt and update the grade to reflect the results from both test submissions. Processing may include but is not limited to one or more of the following: applying a first weighting factor to the original grade, applying a second weighting factor to a test correction, averaging unweighted or weighted grades, and applying a penalty to account for the fact that the user had multiple attempts. This test correction feature provides users with the ability to learn from their mistakes, correct any mistakes made in the initial assessment and have their grade more accurately reflect their comprehension, critical thinking, or writing skills. The updated grade, generated through the grading methods described herein, may help improve the accuracy of the user's evaluation and provide an updated understanding of their performance.

In one set of embodiments of the invention, the grading method and apparatus further includes a system that collects and processes grading responses from multiple users. For each user, the system retrieves, over a user interface, that user's response(s) to a mastery-assessment prompt(s) and accesses an interface to at least one AI-based model to receive that user's grade(s) using the grading methods described elsewhere herein. The system retrieves grades from multiple users. The multiple users may be part of a group of users.

The system may further calibrate or normalize at least one parameter of the grading responses across the group of users. This calibration or normalization process enables the system to adjust the assessments in a consistent manner, allowing for a fair and accurate evaluation of the users' performance. The calibrated or normalized parameters may include but are not limited to a grade to a specific question, other grade-specific content/element(s), or the overall grade.

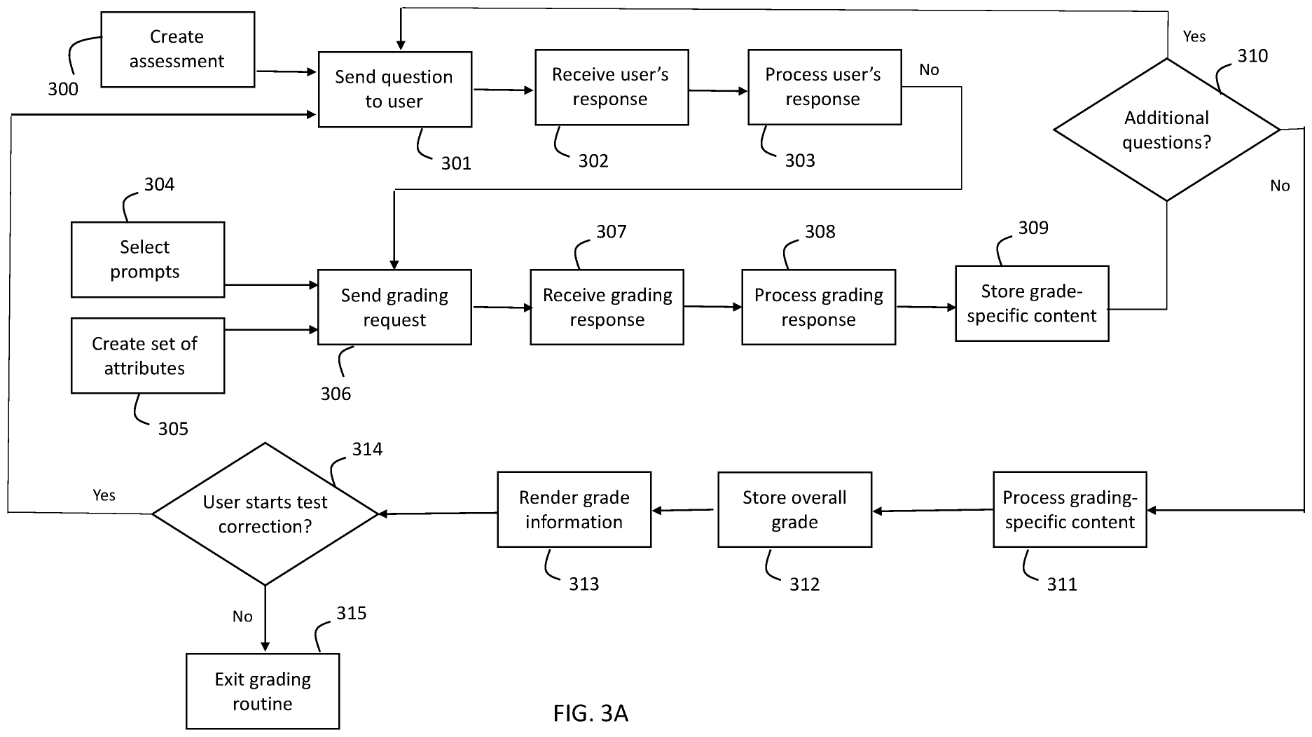

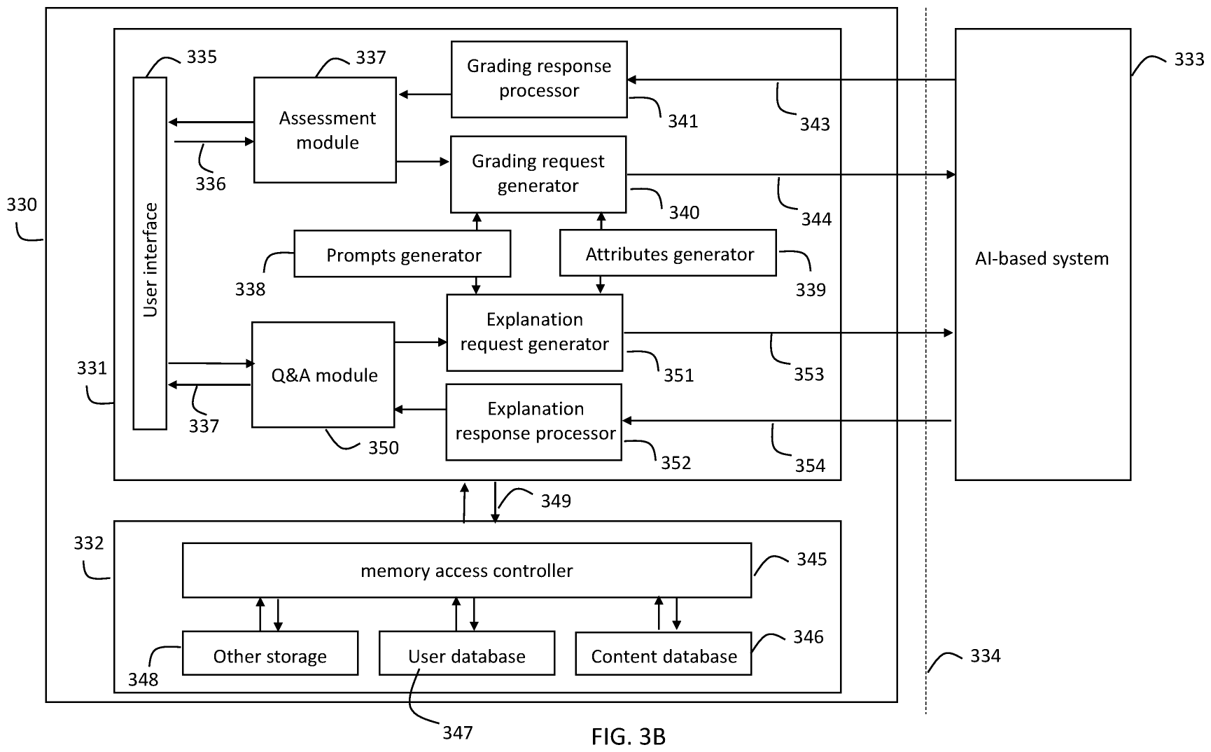

The flow diagram of FIG. 3A illustrates a specific embodiment of the invention disclosed herein. The system may create an assessment designed to assess the user's skill in a specific field (step 300). The assessment can be created using an interface to an AI model or other methods. The assessment can be created using the same, similar or different methods from the methods described elsewhere herein to create a content database. The assessment may contain one or more mastery-assessment prompts and may be stored in temporary or in permanent memory, such as for example in a content database or a user-specific database. In specific embodiments, answers to the one or more mastery-assessment prompts may be stored in memory alongside the mastery-assessment prompts. The assessment may be created in real-time at or around the time the user fills out the assessment, or at an earlier time. The assessment may take into account user-specific historical information such as for example information related to prior engagement with or use of specific components or content of the educational system.

The system may present a first mastery-assessment prompt to the user (step 301) and receive the user's response (step 302). The user's response may then be processed (step 303). Processing may include but is not limited to reformatting the response to align with the grading request format.

The system may further determine or select from a list of prompts one or more prompts (step 304), which includes at least one prompt to request the user's grade for their response. The system may further create a set of attribute values (step 305) for one or more grading requests. This set of attribute values may include but is not limited to specifications for the grading criteria, format of the grading response, approved or recommended sources, labeled grading examples, and additional context.

The system may further send a grading request (step 306) over the interface to the AI model. The grading request may include the mastery-assessment prompt(s), the user's response(s), the prompt(s) and one or more attribute values. Upon receiving the grading request, the AI-based system may process the request to extract or otherwise interpret the mastery-assessment prompt, the user's response, and any other relevant information and generate a grading response containing one or more grading-specific parameter values.

The system may then receive a grading response (step 307) from the AI model through the interface, process it (step 308) to extract or derive grade-specific content/element(s), and store it in memory (step 309). Grade-specific content/element(s) may for example be stored in a generic content database or in a user-specific database, but other storage formats and modalities are also possible. Grade-specific content/element(s) may be stored in permanent or in temporary memory.

The system may further determine (step 310) if additional questions need to be sent to the user. If there are more questions to be sent, the next question may be sent to the user and the steps 301 through 309 may be repeated. The system may retrieve and process the grade-specific content/element(s) from one, multiple, or all questions, and optionally the overall grade from previous assessment attempts to determine an up-to-date overall grade (step 311).

The up-to-date overall grade, possibly along with the mastery-assessment prompt(s) and/or user response(s) may then be stored (step 312) in a user-specific database or another memory modality. The up-to-date overall grade may be stored in temporary or in permanent memory. The system may render the grade information to the user (step 313) and determine (step 314) if the user has started a second attempt test correction. If the user has started a test correction, steps 301 through 314 may be repeated.

FIG. 3B is a block diagram illustrating an example embodiment of various inventions disclosed herein. It should be noted that for simplicity and clarity reasons not all connections between components are shown. For example, attributes generator 339 and prompts generator 338 may interact with memory 332 or components within memory 332 to store or retrieve data, but those connections are not shown for simplicity and clarity reasons.

Functional components of grading system 330 may be implemented by hardware circuitry, by program instructions that are executed by a general-purpose processor, or by a combination of both. Where it is indicated that a processor does something, it may be that the processor does that thing as a consequence of executing instructions read from an instruction memory wherein the instructions provide for performing that thing. Where it is described that a processor performs a particular process, it may be that part of that process is done separately from the electronic device, in a distributed processing fashion. Thus, a description of a process performed by a processor of the electronic device need not be limited to a processor within the electronic device, but perhaps a processor in a support device that is in communication with the electronic device.

One or more functional components may make use of one or more processing units and one or more memory units on the electronic device or on the server. The system implementation can also be distributed, with some program instructions executed on a processor in a central server and others executed locally on a processor in the user's computing device.

The components of the apparatus may include but are not limited to one or more of the following: a user interface 335, an assessment module 337, a prompts generator 338, an attributes generator 339, a grading request generator 340, an grading response processor 341, a Q&A module 350, an explanation request generator 351, an explanation response processor 352, a memory access controller 345, and one or more storage components such as for example content database 346, user database 347, and other temporary or permanent storage 348.

Assessment module 337 may use a general-purpose processor to execute program instructions to select a mastery-assessment prompt and render said mastery-assessment prompt to the user through user interface 335. Assessment module 337 may use interface 349 to memory access controller 345 to retrieve data from memory. For example, an assessment with one or more mastery-assessment prompts may be stored in content database 346 or user database 347 and skills assessor 337 may use one or more pointers or indices to identify or select a mastery-assessment prompt from the database. Assessment module 337 may also access memory 332 for other reasons, such as for example to retrieve user-specific information or historical data from the user. It is also possible that assessment module 337 accesses an interface to an AI-based system to request the AI-based system to create a mastery-assessment prompt according to inventions described elsewhere within this disclosure.

Assessment module 337 may further use a general-purpose processor to execute program instructions to retrieve a user's answer to the rendered mastery-assessment prompt through user interface 335, send a signal to grading request generator 340 to power up or activate, as needed, any circuitry or components necessary to execute the grading request process, and initiate the grading request process.

Upon receiving a signal from assessment module 337, grading request generator 340 may execute a set of program instructions to send one or more explanation requests 344 to AI-based system 333 through AI interface 334 to generate an explanation element. An explanation request may among other things, include one or more of the following: one or more grading request prompts, one or more attribute values, one or more mastery-assessment prompts, and one or more user responses.

One or more content generators within AI-based system 333 may use one or more computational or generative AI models to generate the requested grade-specific content/element(s). The one or more content generator(s) may be implemented as software, hardware, or a combination of both. For example, the AI model may be implemented by hardware circuitry, by program instructions that are executed by a general-purpose or a special-purpose processor, or by a combination of both.

Grading response processor 341 may receive the one or more grading responses 343 with grade-specific elements and may execute program instructions to processes them to extract one or more grade-specific elements.

The one or more grade-specific elements may be stored in memory 332 (e.g. in temporary or permanent memory in other storage component 348). The grading response processor may use interface 349 to memory access controller 345 to store one or more grade-specific elements. They may be stored in temporary memory or in permanent memory. Alternatively, or in addition, the one or more grade-specific elements may also be further processed and sent to assessment module 337 to be rendered to the user through user interface 335. In other embodiments of the invention, grading response processor 352 may communicate directly with user through user interface 335. Other variants are also possible.

The AI-based system 333 may be external to the grading system 330 and may be communicatively coupled to the grading system 330. It is also possible that the AI-based system is embedded within the grading system or that certain components of the AI-based system are external to the grading system and other components are internal.

The grading apparatus 330 may also include a Q&A module 350 that communicates with user over user interface 335 and allows the user, after receiving an explanation, to ask one or more follow-on questions. Upon receiving a follow-on question, Q&A module 350 may use a general-purpose processor to execute program instructions to process the follow-on question and send a signal, including portions or all of the follow-on question, to explanation request generator 351 to power up or otherwise activate as needed any circuitry or hardware required for executing the explanation request process, and to initiate the explanation request process.

Prompts generator 338 may use a general-purpose processor to execute program instructions to generate or select one or more prompts used to query AI-based system 333. A list, array, or database of prompts may be stored in memory 332 (e.g. in other storage component 348) and prompts generator 338 may use one or more pointers or indices to identify one or more relevant prompts from the list, array, or database of prompts or otherwise access the list, array, or database of prompts for example through memory access controller 349.

Attributes generator 339 may use a general-purpose processor to execute program instructions to define a set of attribute values used to specify one or more parameters of the explanation. Examples of attributes include but are not limited to characteristics of the explanation element such as for example language, difficulty level, style, tone, or one or more length indications; format type of the explanation element such as for example written text, speech, video, doodle, presentation; format characteristics of the explanation element such as for example font size, maximum number of words per slide, voice tone, voice emotion, pace, accentuation of specific words or phrases, syntax of response, use of specific tags, capitalization or punctuation; approved or recommended sources to use; a format template or one or more example explanations implemented in the desirable format; or attributes specifying additional context.

The list(s), array(s), or JSON object(s) of all attributes may be stored in memory 332 (e.g. in other storage component 348) and attributes generator 339 may use one or more indices or pointers to identify one or more relevant attribute values from the list(s), array(s), or JSON object(s) of attributes or otherwise access list(s), array(s), or JSON object(s) for example through memory access controller 345.

Upon receiving a signal from Q&A module 350, explanation request generator 351 may execute a set of program instructions to send one or more explanation requests 353, including one or more prompts and/or attribute values, to AI-based system 333 through AI interface 334 to generate an explanation element. One or more content generators within AI-based system 333 may use one or more computational or generative AI models to generate the requested explanation element. The one or more content generator(s) may be implemented as software, hardware, or a combination of both. For example, the AI model may be implemented by hardware circuitry, by program instructions that are executed by a general-purpose or a special-purpose processor, or by a combination of both.

Explanation response processor 352 may receive the one or more explanation responses 354 and may execute program instructions to processes them to extract one or more explanation elements.

The one or more explanation elements may be stored in memory 332 (e.g. in temporary or permanent memory in other storage component 348). The explanation response processor may use interface 349 to memory access controller 345 to store one or more explanation elements. They may be stored in temporary memory or in permanent memory. Alternatively, or in addition, the one or more explanation elements may also be further processed and sent to Q&A module 350 to be rendered to the user through user interface 335. In other embodiments of the invention, explanation response processor 352 may communicate directly with user through user interface 335. Other variants are also possible.

### Systems and Methods for Customizing Content Delivery Formats

In embodiments of the invention, an online educational platform is disclosed that leverages an interface to one or more artificial intelligence models to deliver personalized learning pathways. The platform includes a customization method and apparatus that utilizes a natural language interface to one or more generative Artificial Intelligence models to individualize the delivery format of educational content.

The method includes retrieving information about the desirable content format and retrieving content in a first format. At least one prompt is defined to request one or more formatting tasks, and a set of attributes is created that may include one or more of the following: (1) attributes specifying the requested format type of a second format (e.g. video, speech, doodle, text); (2) attributes specifying requested format characteristics of the second format (e.g. language, font size, max. number of words per slide, voice tone, voice emotion, pace, accentuation of specific words or phrases, difficulty level of vocabulary); (3) attributes specifying the format of the returned reformatted element (e.g. syntax of response, use of specific tags, capitalization or punctuation, maximum length); (4) attributes specifying approved or recommended sources to use; (5) attributes with a template for the second format or one or more examples of second format implementations; (6) attributes specifying additional context; and (7) attributes specifying approved or recommended sources to use.

The system may consist of multiple interfaces to multiple generative AI models and the method may further process the desirable content format to determine which interface to use.

The method then sends at least one reformatting request over the selected interface to at least one regenerative Artificial Intelligence model, which request includes the prompt, the content in the first format, and at least one attribute from the set of attributes. A formatting response is received over the interface, and the response is processed to extract or derive the reformatted content. The reformatted content is then rendered to the user.

The apparatus may include a server with processing and storage resources, a database for storing content and metadata, and one or more interfaces for communication with the one or more regenerative Artificial Intelligence models. The server and interfaces may be configured to perform the method steps described above, and the database may be configured to store the content, metadata, and attributes.

The disclosed system and method provide a dynamic and personalized educational experience, as it presents a scalable solution to reformatting educational content to meet an individual's or group of users' specific needs and preferences through the use of a natural language interface to one or more generative Artificial Intelligence models. Additionally, the customization features of the system make it easily adaptable to different cultures, special needs groups, or other groups with diverse requirements, further enhancing the personalized learning experience for all users. By leveraging the natural language interface to a generative Artificial Intelligence model, the system offers an intuitive and user-friendly way for students to individualize their learning journey and achieve their full potential.

In various embodiments of the invention discussed in this disclosure, methods and systems described in this disclosure may be implemented as a set of program instructions that can be stored in memory and that can be executed by a general-purpose or special-purpose processor on an electronic device such as a laptop or mobile phone, or on a central server.

The figures and the description in this disclosure relate to preferred embodiments by way of illustration only. It should be noted that from the discussion, alternative embodiments of the structures and methods disclosed herein will be readily recognized as viable alternatives that may be employed without departing from the principles of what is claimed.

Having thus described several aspects of at least one embodiment of this invention, it is to be appreciated various alterations, modifications, and improvements will readily occur to those skilled in the art. Such alterations, modifications, and improvements are intended to be part of this disclosure and are intended to be within the spirit and scope of the invention. Accordingly, the foregoing description and drawings are by way of example only. What is claimed is:

1. A computer-implemented method generating assessment content via interaction with at least one of a computational artificial intelligence (AI) model or a generative AI model, the method comprising:
(A) receiving, via a user interface, user input;
(B) analyzing at least one aspect of the received user input to formulate a set of prompts for querying the AI model;
(C) identifying at least one content element from a content database based on the analysis of at least one aspect of the user input, wherein the relevance of the at least one content element is determined in relation to at least one aspect of the user input;
(B) generating a first set of attribute values for a first assessment content element, wherein the set comprises at least one attribute characterizes the identified content element or a derivative representation thereof;
(C) constructing the assessment content element by:
(C-1) transmitting a creation request for at least a portion of the assessment content element to the AI model over an interface;
(C-2) receiving a response from the AI model comprising at least a portion of the assessment content element;
(C-3) processing the received response to extract a specified portion of the assessment content element; and
(C-4) repeating C-1 through C-4 iteratively until the entire assessment content element is generated;
(D) processing the generated assessment content element, wherein the processing comprises at least one of the following operations:
(D-1) aggregating the generated portions to form a unified assessment content element;
(D-2) assigning metadata tags reflective of one or more attributes from the first set of attribute values to facilitate subsequent retrieval, categorization, or analysis; or
(D-3) performing any other processing operation that enhances, modifies, or utilized the assessment content element for its intended purpose.
which may include concatenating portions of the assessment content element, tagging the assessment content element with one or more attributes from the set of attributes; and
(E) storing the assessment content element in a content database and/or transmitting the assessment content element to a content delivery system for presentation to a reviewer or assessment taker.

2. The method of claim 1, further comprising determining the relevance of the at least one content element from the content database by:
(A) Generating vectorized representations for both the at least one user input and content elements within the content database that represent their semantic content;
(B) Comparing the vectorized representation of the at least one user input with the vectorized representations of the content elements; and
(C) Employing a similarity determination algorithm to identify the at least one content element whose vectorized representation demonstrates the highest semantic congruence with the vectorized representation of the user input.

3. The method of claim 2, further comprising adjusting the vector representations of at least one subset of the content elements in a content database based upon aggregated performance data, wherein said adjusting repositions the embeddings within the vector space based on at least one of an inferred difficulty level, an inferred test format adequacy metric, or other inferred metric that predicts optimal learning outcomes for specific student groups, the adjustment being executed without altering the original educational content of the content elements.

4. The method of claim 3, wherein the adjustment of the vector representations involves using one or more machine learning techniques selected from the group consisting of supervised learning, unsupervised learning, semi-supervised learning, reinforcement learning, and transfer learning, for dynamically repositioning the embeddings within the vector space.

5. The method of claim 3, where the at least one subset of the content elements is a set of curriculum content elements the repositioning of the embeddings is based on an inferred difficulty level.

6. The method of claim 3, where the at least one subset of the content elements is a set of assessment content elements the repositioning of the embeddings is based on an inferred test format adequacy metric.

7. An apparatus for generating assessment content through interaction with at least one of a computational artificial intelligence (AI) model or a generative AI model, comprising:
(A) A user interface configured to receive user input;
(B) A processing unit configured to analyze at least one aspect of the received user input to formulate a set of prompts for querying the AI model and to identify at least one content element from a content database based on the analysis, wherein the relevance of the at least one content element is determined in relation to at least one aspect of the user input;
(C) A generator configured to generate a first set of attribute values for a first assessment content element, wherein the set comprises at least one attribute characterizing the identified content element or a derivative representation thereof;
(D) A constructor configured to:
(D-1) Transmit a creation request for at least a portion of the assessment content element to the AI model over an interface,
(D-2) Receive a response from the AI model comprising at least a portion of the assessment content element,
(D-3) Process the received response to extract a specified portion of the assessment content element,
(D-4) Repeat the aforementioned steps iteratively until the entire assessment content element is generated;
(E) A processor configured to aggregate the generated portions to form a unified assessment content element, assign metadata tags reflective of one or more attributes from the first set of attribute values, and perform any other processing operation that enhances, modifies, or utilizes the assessment content element for its intended purpose;
(F) A storage unit configured to store the assessment content element in a content database and/or a transmission unit configured to transmit the assessment content element to a content delivery system for presentation.

8. The apparatus of claim 7, further comprising:
(A) A vectorization unit configured to generate vectorized representations for both the user input and content elements within the content database that represent their semantic content;
(B) A comparison unit configured to compare the vectorized representation of the user input with the vectorized representations of the content elements;
(C) A similarity determination unit employing a similarity determination algorithm to identify the content element whose vectorized representation demonstrates the highest semantic congruence with the vectorized representation of the user input.

9. The apparatus of claim 8, further comprising an adjustment unit configured to adjust the vector representations of at least one subset of the content elements in the content database based upon aggregated performance data, wherein the adjustment repositions the embeddings within the vector space based on at least one of an inferred difficulty level, an inferred test format adequacy metric, or other inferred metric that predicts optimal learning outcomes for specific student groups, executed without altering the original educational content of the content elements.

10. The apparatus of claim 9, wherein the adjustment unit employs one or more machine learning techniques selected from the group consisting of supervised learning, unsupervised learning, semi-supervised learning, reinforcement learning, and transfer learning, for dynamically repositioning the embeddings within the vector space.

11. The apparatus of claim 9, wherein the at least one subset of the content elements comprises a set of curriculum content elements and the repositioning of the embeddings is based on an inferred difficulty level.

12. The apparatus of claim 9, wherein the at least one subset of the content elements comprises a set of assessment content elements and the repositioning of the embeddings is based on an inferred test format adequacy metric.
